(19) United States
(12) Patent Application Publication
(10) Pub. No.: US 2025/0105963 A1
(43) Pub. Date: Mar. 27, 2025

(54) Positioning Reference Signals Configuration based on Discontinuous Reception

(71) Applicant: Telefonaktiebolaget LM Ericsson (publ), Stockholm (SE)

(72) Inventors: Ritesh Shreevastav, Upplands Väsby (SE); Muhammad Ali Kazmi, Reston, VA (US)

(21) Appl. No.: 18/729,774

(22) PCT Filed: Feb. 6, 2023
(86) PCT No.: PCT/SE2023/050093

§ 371 Date: Jul. 17, 2024

Related U.S. Application Data
(60) Provisional application No. 63/308,127, filed on Feb. 9, 2022.

(51) Int. Cl. H04L 5/00; H04W 24/08; H04W 52/02; H04W 64/00; H04W 76/28

(52) U.S. Cl. CPC H04L 5/0048; H04W 24/08; H04W 52/0235; H04W 64/006; H04W 76/28

(57) ABSTRACT

A method for a user equipment (UE) for positioning in a radio access network (RAN). The UE receives from a positioning node, a plurality of configurations for positioning reference signals (PRS) transmitted by a RAN node and a mapping between the plurality of PRS configurations and one or more of the following: a plurality of sets of one or more UE discontinuous reception (DRX) cycles, and a plurality of sets of one or more positioning quality of service (pQoS) targets. The UE obtains one of the following based on the mapping: a PRS configuration based on a DRX cycle configured for the UE by the RAN node: or a DRX cycle based on a first pQoS target or on a PRS configuration to be used for positioning measurements; and performs positioning measurements on PRS transmitted by the RAN node according to the obtained PRS configuration and on the DRX cycle.

### TECHNICAL FIELD

The present disclosure generally relates to wireless communication networks, and more specifically to configuring network transmission of positioning reference signals (PRS) in a manner that accommodates user equipment (UE) reception of PRS according to a discontinuous reception (DRX) cycle used by the UE to reduce energy consumption.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region,” with the term AMF being described in more detail below.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

FIG. 2 shows another high-level view of an exemplary 5G network architecture, including a NG-RAN 299 and 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to the access and mobility management functions (AMFs, e.g., 230a,b) via respective NG-C interfaces and to user plane functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth-generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one more cells, such as cells 211a-b and 221a-b shown in FIG. 2. Depending on the particular cell in which it is located, a UE 205 can communicate with the gNB or ng-eNB serving that particular cell via the NR or LTE radio interface, respectively. Although FIG. 2 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

The radio resource control (RRC) protocol controls communications between UE and gNB at the radio interface as well as mobility of a UE between cells in the NG-RAN. After a UE registers with 5GC, it can be in one of three different RRC states with respect to the NG-RAN. In each of these RRC states, the NG-RAN can configure the UE with a discontinuous reception (DRX) cycle to reduce UE energy consumption. Each DRX cycle includes a DRX On duration (also called DRX active time) and a DRX Off duration (also called DRX inactive time).

3GPP standards provide various ways for positioning (e.g., determining the position of, locating, and/or determining the location of) UEs operating in NR networks. In general, a positioning node configures a target device (e.g., UE) and/or radio network nodes (RNN, e.g., gNB, ng-eNB, or RNN dedicated for positioning measurements) to perform one or more positioning measurements according to one or more positioning methods. For example, the positioning measurements can include timing (and/or timing difference) measurements on UE, network, and/or satellite transmissions. The positioning measurements are used by the target device, the measuring node, and/or the positioning node to determine the target device's location.

Positioning in NR Rel-16 was developed based on network-transmitted positioning reference signals (PRS), which can provide added value in terms of enhanced location capabilities. For example, PRS transmission in low and high frequency bands (i.e., below and above 6 GHZ) and use of massive antenna arrays provide additional degrees of freedom to substantially improve positioning accuracy. Further enhancements are planned for NR Rel-17, including “on-demand PRS” whereby the UE can request the network to transmit PRS in a configuration that facilitates UE positioning measurements and (optionally) position determination.

### SUMMARY

However, DRX can cause various problems, issues, and/or difficulties with respect to UE positioning measurements based on network-transmitted PRS. For example, the UE's configured DRX On durations may align poorly with the network-transmitted PRS, causing significant latency in the UE's PRS measurements and, consequently, determination of the UE's position (e.g., by UE or network) based on those PRS measurements.

Embodiments of the present disclosure provide specific improvements to positioning of UEs in a wireless network, such as by providing, enabling, and/or facilitating solutions to overcome exemplary problems summarized above and described in more detail below.

Embodiments include methods (e.g., procedures) for a UE for positioning in a radio access network (RAN).

These exemplary methods can include receive, from a positioning node, a plurality of configurations for PRS transmitted by a RAN node and a mapping between the plurality of PRS configurations and one or more of the following: a plurality of sets of one or more UE DRX cycles, and a plurality of sets of one or more positioning quality of service (pQoS) targets. These exemplary methods can also include obtaining one of the following based on the mapping:
a PRS configuration based on a DRX cycle configured for the UE by the RAN node; or
a DRX cycle based on a first pQoS target or on a PRS configuration to be used for positioning measurements.

These exemplary methods can also include performing positioning measurements on PRS transmitted by the RAN node according to the obtained PRS configuration and on the DRX cycle.

In various embodiments, these exemplary methods can also include determining a need to perform positioning measurements associated with a first pQoS target. In various embodiments, the plurality of configurations can be differentiated from each other based on one or more of the following characteristics or parameters:
PRS transmission periodicity;
PRS transmission bandwidth;
PRS resource repetition factor;
PRS symbols in PRS resource;
PRS muting pattern;
PRS subcarrier spacing;
PRS resource set periodicity and slot offset;
PRS resource time gap
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

In some embodiments, each pQoS target is associated with one or more of the following: an accuracy criterion, and a latency criterion. In some of these embodiments, the plurality of PRS configurations include:
a first PRS configuration associated with a high accuracy criterion and a low latency criterion;
a second PRS configuration associated with a medium accuracy criterion and a medium latency criterion; and
a third PRS configuration associated with a low accuracy criterion and a high latency criterion.

In some embodiments, the mapping includes the following:
an explicit mapping between the plurality of PRS configurations and the respective plurality of sets of DRX cycles, and
an implicit mapping between the plurality of PRS configurations and a corresponding plurality of pQoS targets, based on the DRX cycles included in the respective sets.

In some of these embodiments, obtaining based on the mapping can include receiving from the RAN node an indication of the DRX cycle configured for the UE and selecting the PRS configuration associated with the configured DRX cycle according to the mapping.

In other of these embodiments, obtaining based on the mapping can include the operations receiving from the RAN node an indication of a first DRX cycle configured for the UE; receiving from the positioning node an indication of the first pQoS target and, based on the mapping, determining whether positioning measurements performed based on the first DRX cycle will meet the first pQoS target.

In some variants, obtaining based on the mapping can also include: based on determining that positioning measurements performed based on the first DRX cycle will not meet the first pQoS target, sending to the RAN node a request for configuration of a DRX cycle that meets the first pQoS target; and receiving, from the RAN node in response to the request, an indication of the DRX cycle configured for the UE.

In some further variants, the request includes an indication one or more recommended DRX cycles that facilitate UE positioning measurements that meet the first pQoS target. In some further variants, the DRX cycle configured for the UE is less than the first DRX cycle. In some further variants, performing the positioning measurements can include initiating the positioning measurements according to the PRS configuration based on the first DRX cycle, suspending the positioning measurements based on determining that positioning measurements performed based on the first DRX cycle will not meet the first pQoS target, and resuming the positioning measurements based on the DRX cycle configured for the UE.

In other of these embodiments, performing the positioning measurements can include initiating the positioning measurements according to the PRS configuration based on the first DRX cycle, stopping the positioning measurements based on determining that positioning measurements performed based on the first DRX cycle will not meet the first pQoS target, and sending to the positioning node an indication that the UE stopped the positioning measurements and an indication of a cause for the stopping. In some variants, stopping the positioning measurements is further based on determining that the first DRX cycle is one or more of the following: less than a threshold, or a shortest available DRX cycle for the UE's RRC state with respect to the RAN node.

In other embodiments, the mapping includes:
a first mapping between the plurality of PRS configurations and a corresponding plurality of sets of pQoS targets; and
a second mapping of a single set of DRX cycles to all of the PRS configurations and to all of the sets of pQOS targets.

In some of these embodiments, obtaining based on the mapping can include receiving from the positioning node an indication of the first pQoS target and selecting the PRS configuration associated with the first QoS target according to the mapping.

Other embodiments include methods (e.g., procedures) for a positioning node associated with a radio access network (RAN).

In various embodiments, these exemplary methods can include one of various operations. For example, the positioning node can send, to a UE, a plurality of configurations for positioning reference signals (PRS) transmitted by a RAN node and a mapping between the plurality of PRS configurations and one or more of the following:
a PRS configuration based on a DRX cycle configured for the UE by the RAN node; or
a DRX cycle based on the first pQoS target or on a PRS configuration to be used for the positioning measurements.

As another example, the positioning node can select a PRS configuration for the UE based on a DRX cycle configured for the UE by the RAN node and on the mapping. As another example, the positioning node can, based on the mapping, determine that positioning measurements performed by the UE based on the DRX cycle will not meet a first pQoS target.

In various embodiments, the plurality of PRS configurations are differentiated from each other based any of the characteristics or parameters summarized above for UE embodiments.

In some embodiments, each pQoS target is associated with one or more of the following: an accuracy criterion, and a latency criterion. In some of these embodiments, the plurality of PRS configurations can include first, second, and third configurations such as summarized above for UE embodiments.

In various embodiments, the mapping can have any of the characteristics or features summarized above for UE embodiments.

In some embodiments, these exemplary methods can also include sending to the RAN node a request for a DRX cycle configured for the UE by the RAN node and receiving from the RAN node a response including an indication of the DRX cycle configured for the UE. In such case, selecting the PRS configuration is based on the mapping and on the DRX cycle indicated by the RAN node. In some of these embodiments, these exemplary methods can also include sending the selected PRS configuration (or an indication thereof) to the UE and causing the RAN node to transmit PRS in accordance with the selected PRS configuration.

In other embodiments, these exemplary methods can also include, based on determining that positioning measurements performed by the UE based on the DRX cycle will not meet the pQOS target, sending to a CN node a request to configure the UE with a different DRX cycle that facilitates UE positioning measurements that meet the first pQoS target. In some of these embodiments, these exemplary methods can also include, based on the mapping, determining one or more recommended DRX cycles that facilitate UE positioning measurements that meet the first pQOS target. In some variants, the request to the CN node includes an indication of the one or more recommended DRX cycles.

Other embodiments include methods (e.g., procedures) for a network node of a RAN.

These exemplary methods can include sending, to a UE, an indication of a DRX cycle configured for the UE. These exemplary methods can also include transmitting PRS for measurement by the UE based on the configured DRX cycle and on a first pQOS target. The PRS are transmitted according to a PRS configuration selected by the UE or by a positioning node. The PRS configuration or the DRX cycle is selected based on a mapping between a plurality of PRS configurations and one or more of the following: a plurality of sets of one or more UE DRX cycles, and a plurality of sets of one or more pQoS targets.

In various embodiments, the plurality of PRS configurations are differentiated from each other based any of the characteristics or parameters summarized above for UE embodiments.

In some embodiments, each pQOS target is associated with one or more of the following: an accuracy criterion, and a latency criterion. In some of these embodiments, the plurality of PRS configurations can include first, second, and third configurations such as summarized above for UE embodiments.

In various embodiments, the mapping can have any of the characteristics or features summarized above for UE embodiments.

In some embodiments, these exemplary methods can also include sending to the UE an indication of a first DRX cycle configured for the UE and receiving from the UE a request for configuration of a DRX cycle that meets the first pQoS target. The indication of the DRX cycle configured for the UE is sent in response to the request. In some of these embodiments, these exemplary methods can also include selecting the DRX cycle configured for the UE based on one or more of the following:
one or more recommended DRX cycles that facilitate UE positioning measurements that meet the first pQoS target, indicated in the request;
the mapping; and
the PRS configuration selected by the UE or by the positioning node.

In some of these embodiments, the DRX cycle configured for the UE is less than the first DRX cycle.

In other embodiments, these exemplary methods can also include receiving from the positioning node a request for a DRX cycle configured for the UE by the RAN node and sending to the positioning node a response including an indication of the DRX cycle configured for the UE. In some of these embodiments, these exemplary methods can also include receiving from the positioning node a request or a command to transmit the PRS according to the PRS configuration selected by the positioning node based on the mapping and the DRX cycle configured for the UE by the RAN node. The RAN node can transmit the PRS in response to the request or command.

Other embodiments include UEs (e.g., wireless devices, etc.), positioning nodes (e.g., LMFs, E-SMLCs, SUPL nodes, etc.), and RAN nodes (e.g., base stations, eNBs, gNBs, ng-eNBs, TRPs, etc.) configured to perform operations corresponding to any of these exemplary methods described herein. Other embodiments include non-transitory, computer-readable media storing program instructions that, when executed by processing circuitry, configure such UEs, positioning nodes, or RAN nodes to perform operations corresponding to any of these exemplary methods described herein.

Embodiments described herein embodiments herein can allow, enable, and/or facilitate a network to provide UE DRX configurations that are specific to and/or compatible with PRS configurations used by the UE, such as a UE-selected one of multiple predefined PRS configurations. In this manner, embodiments provide an improved and/or optimal tradeoff between positioning latency and UE energy consumption.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 is a block diagram illustrating a high-level architecture for supporting UE positioning in NR networks.

FIG. 5 shows an ASN.1 data structure for an exemplary NR-DL-PRS-AssistanceData information element (IE).

FIG. 6 shows a signal flow diagram for an exemplary multi-RTT positioning procedure.

FIGS. 7-8 show two exemplary signaling procedures used to obtain a positioning reference signal (PRS) configuration, in accordance with two different scenarios.

FIG. 9 is a timing diagram that illustrates exemplary connected discontinuous reception (C-DRX) operation of a UE.

FIG. 10 is a signaling diagram of a procedure between a UE, a RAN node, an CN node, and a positioning node, according to various embodiments of the present disclosure.

FIG. 11 is a signaling diagram of a procedure between a UE, a RAN node, and a positioning node, according to various embodiments of the present disclosure.

FIG. 12 (which includes FIGS. 12A-B) shows a flow diagram of an exemplary method (e.g., procedure) for a UE, according to various exemplary embodiments of the present disclosure.

FIG. 13 shows a flow diagram of an exemplary method (e.g., procedure) for a positioning node (e.g., LMF), according to various embodiments of the present disclosure.

FIG. 14 shows a flow diagram of an exemplary method (e.g., procedure) for a RAN node (e.g., gNB, TRP, etc.), according to various embodiments of the present disclosure.

FIG. 15 shows a communication system according to various embodiments of the present disclosure.

FIG. 16 shows a UE according to various embodiments of the present disclosure.

FIG. 17 shows a network node according to various embodiments of the present disclosure.

FIG. 18 shows host computing system according to various embodiments of the present disclosure.

FIG. 19 is a block diagram of a virtualization environment in which functions implemented by some embodiments of the present disclosure may be virtualized.

FIG. 20 illustrates communication between a host computing system, a network node, and a UE via multiple connections, at least one of which is wireless, according to various embodiments of the present disclosure.

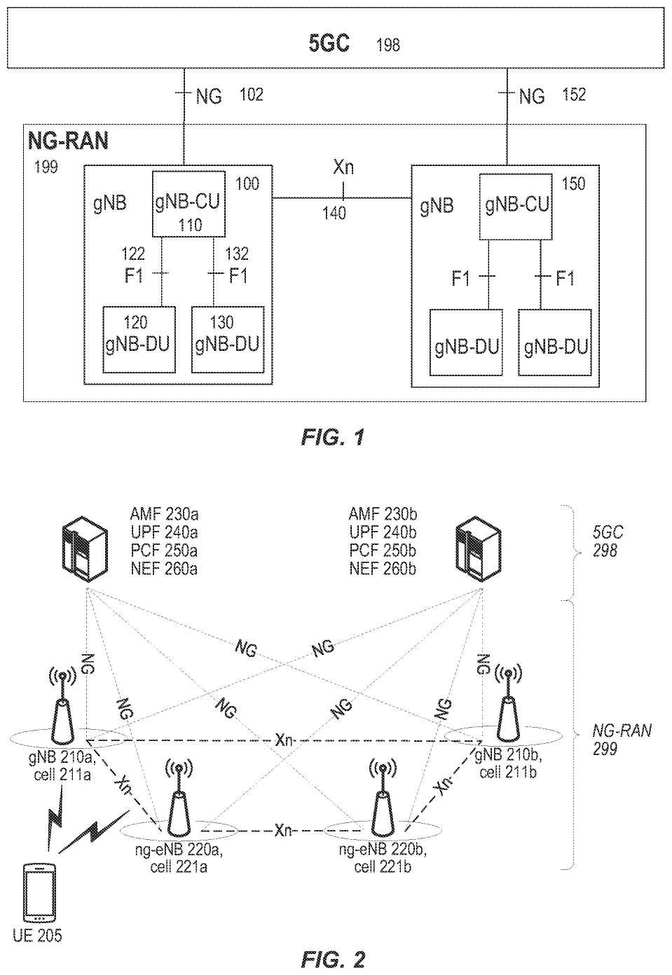

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices.

Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile 20) stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Location server: As used herein, “location server” can refer to a network node with positioning functionality, e.g., ability to provide assistance data and/or request positioning measurements and/or calculate a location based on positioning measurements. A location server may or may not be part of a base station.
Positioning signals: As used herein, “positioning signals” may include any signal or channel to be received by the UE for performing a positioning measurement such as a DL reference signal, PRS, SSB, synchronization signal, DM-RS, CSI-RS, etc.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), and/or identifier detection/measurement (e.g., cell ID, beam ID, etc.) that are configured for a positioning method (e.g., OTDOA, E-CID, etc.). UE positioning measurements may be reported to a network node or may be used for positioning purposes by the UE.
Positioning beam: As used herein, a “positioning beam” can include any beam carrying at least one positioning signal and/or that is used for a positioning purpose such as for measurements supporting one or more positioning methods (e.g., OTDOA, AOA, etc.) . . . . A positioning beam can have its own explicit identity or can be identified through an index associated with a specific signal that the beam carries.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

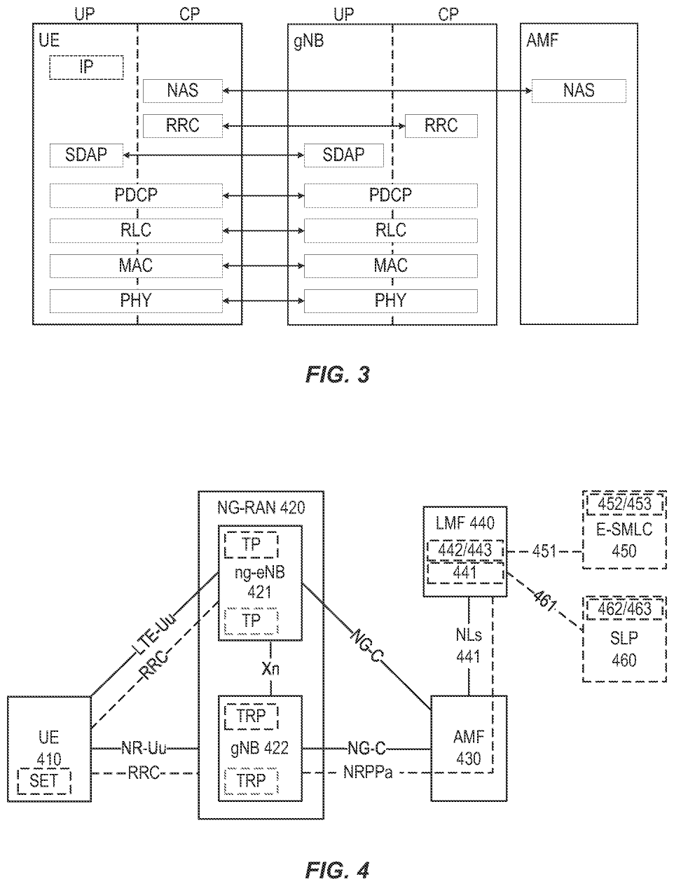

Positioning-related information, such as assistance data and positioning measurements, can be communicated between network and UE via user plane (UP) or control plane (CP). FIG. 3 shows an exemplary configuration of NR UP and CP protocol stacks between a UE, a gNB, and an AMF. Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB.

Three important functional elements of the 3GPP positioning architecture are LCS Client, LCS target, and LCS Server. The LCS Server is a physical or logical entity (e.g., a location server) that manages positioning for an LCS target (e.g., a UE) by collecting measurements and other location information, assisting the LCS target in measurements when necessary, and estimating the LCS target location. An LCS Client is a software and/or hardware entity that interacts with an LCS Server for the purpose of obtaining location information for one or more LCS targets (i.e., the entities being positioned) such as a UE. LCS Clients may also reside in the LCS targets themselves. An LCS Client sends a request to an LCS Server to obtain location information, and the LCS Server processes and serves the received requests and sends the positioning result and optionally a velocity estimate to the LCS Client. A positioning request can be originated from the terminal or a network node or external client.

Position calculation can be conducted, for example, by the LCS Server (e.g., E-SMLC or SLP) or by the LCS target (e.g., a UE). The former approach corresponds to the UE-assisted positioning mode when it is based on UE measurements, whilst the latter corresponds to the UE-based positioning mode. Additionally, the following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. GNSS information retrieved by the UE, supported by assistance information provided to the UE from the E-SMLC.
OTDOA (Observed Time Difference of Arrival). The UE receives and measures Global Navigation Satellite System (GNSS) signals, supported by assistance information provided to the UE from E-SMLC.
UTDOA (Uplink TDOA). The UE is requested to transmit a specific waveform that is detected by multiple location measurement units (LMUs, which may be standalone, co-located or integrated into an eNB) at known positions. These measurements are forwarded to the E-SMLC for multilateration.
Multi-RTT: The device (e.g., UE) computes UE Rx-Tx time difference and gNBs compute gNB Rx-Tx time difference. The results are combined to find the UE position based upon round trip time (RTT) calculation.
DL angle of departure (DL-AoD): gNB or LMF calculates the UE angular position based upon UE DL RSRP measurement results (e.g., of PRS transmitted by network nodes).
UL angle of arrival (UL-AoA): gNB calculates the UL AoA based upon measurements of a UE's UL SRS transmissions.

In addition, one or more of the following positioning modes can be utilized in each of the positioning methods listed above:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.

The detailed assistance data may include information about network node locations, beam directions, etc. The assistance data can be provided to the UE via unicast or via broadcast.

FIG. 4 is a block diagram illustrating a high-level architecture for supporting UE positioning in NR networks. NG-RAN 420 can include nodes such as gNB 422 and ng-eNB 421, similar to the architecture shown in FIG. 2. Each ng-eNB may control several transmission points (TPs), such as remote radio heads. Similarly, each gNB may control several TRPs. Some or all of the TPs/TRPs may be DL-PRS-only for support of PRS-based TBS.

In addition, the NG-RAN nodes communicate with an AMF 430 in the 5GC via respective NG-C interfaces (both of which may or may not be present), while AMF 430 communicates with a location management function (LMF) 440 communicate via an NLs interface 441. An LMF supports various functions related to determination of UE locations, including location determination for a UE and obtaining DL location measurements or a location estimate from the UE, UL location measurements from the NG RAN, and non-UE associated assistance data from the NG RAN.

In addition, positioning-related communication between UE 410 and the NG-RAN nodes occurs via the RRC protocol, while positioning-related communication between NG-RAN nodes and LMF occurs via an NRPPa protocol. Optionally, the LMF can also communicate with an E-SMLC 450 and a SUPL 460 in an LTE network via communication interfaces 451 and 461, respectively. Communication interfaces 451 and 461 can utilize and/or be based on standardized protocols, proprietary protocols, or a combination thereof.

LMF 440 can also include, or be associated with, various processing circuitry 442, by which the LMF performs various operations described herein. Processing circuitry 442 can include similar types of processing circuitry as described herein in relation to other network nodes (see, e.g., description of FIG. 17). LMF 440 can also include, or be associated with, a non-transitory computer-readable medium 443 storing instructions (also referred to as a computer program program) that can facilitate the operations of processing circuitry 442. Medium 443 can include similar types of computer memory as described herein in relation to other network nodes (see, e.g., description of FIG. 17). Additionally, LMF 440 can include various communication interface circuitry 441 (e.g., Ethernet, optical, and/or radio transceivers) that can be used, e.g., for communication via the NLs interface. For example, communication interface circuitry 441 can be similar to other interface circuitry described herein in relation to other network nodes (see, e.g., description of FIG. 17).

Similarly, E-SMLC 450 can also include, or be associated with, various processing circuitry 452, by which the E-SMLC performs various operations described herein. Processing circuitry 452 can include similar types of processing circuitry as described herein in relation to other network nodes (see, e.g., description of FIG. 17). E-SMLC 450 can include, or be associated with, a non-transitory computer-readable medium 453 storing instructions (also referred to as a computer program program) that can facilitate the operations of processing circuitry 452. Medium 453 can include similar types of computer memory as described herein in relation to other network nodes (see, e.g., description of FIG. 17). E-SMLC 450 can also have communication interface circuitry that is appropriate for communicating via interface 451, which can be similar to other interface circuitry described herein in relation to other network nodes (see, e.g., description of FIG. 17).

Similarly, SLP 460 can also include, or be associated with, various processing circuitry 462, by which the SLP performs various operations described herein. Processing circuitry 662 can include similar types of processing circuitry as described herein in relation to other network nodes (see, e.g., description of FIG. 17). SLP 460 can also include, or be associated with, a non-transitory computer-readable medium 463 storing instructions (also referred to as a computer program program) that can facilitate the operations of processing circuitry 462. Medium 463 can include similar types of computer memory as described herein in relation to other network nodes (see, e.g., description of FIG. 17). SLP 460 can also have communication interface circuitry that is appropriate for communicating via interface 461, which can be similar to other interface circuitry described herein in relation to other network nodes (see, e.g., description of FIG. 17).

In a typical operation, the AMF receives a request for a location service associated with a particular target UE from another entity (e.g., a gateway mobile location center (GMLC)), or the AMF itself can initiate some location service on behalf of a particular target UE (e.g., for an emergency call from the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

An LMF may have a signaling connection to an E-SMLC, enabling the LMF to access information from E-UTRAN, e.g., to support E-UTRA OTDOA positioning using DL measurements obtained by a target UE. An LMF can also have a signaling connection to an SLP, the LTE entity responsible for user-plane positioning.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is 20) used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., location server). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that are to be used for OTDOA positioning measurements by the UE.

PRS were introduced in LTE Rel-9 for because cell-specific reference signals (CRS) were not sufficient for positioning. In particular, CRS could not guarantee the required high probability of detection. In general, a neighbor cell's synchronization signals (PSS/SSS) and reference signals is generally detectable when the Signal-to-Interference-and-Noise Ratio (SINR) is at least-6 dB. Simulations have shown, however, that this can be only guaranteed for 70% of all cases for the third-best detected cell, meaning that in at least 30% of cases only two neighboring cells are detected. Even this level of performance is based on an interference-free environment, which cannot be ensured in a real-world scenario.

Even so, PRS have some similarities with CRS. For example, PRS is a pseudo-random QPSK sequence that is mapped in diagonal patterns with shifts in frequency and time to avoid collision with CRS and an overlap with the control channels (PDCCH). PRS are periodically transmitted on a positioning frequency layer in PRS resources by the gNB. The information about the PRS resources is signaled to the UE by the positioning node via higher layers but may also be provided by base station via broadcast (discussed later).

Each positioning frequency layer includes PRS resource sets, where each PRS resource set includes one or more PRS resources. All DL PRS resources within one PRS resource set are configured with the same PRS resource periodicity Iₚₑᵣ^{TPRS} from the available set of 2^{μ}{4, 8, 16, 32, 64, 5, 10, 20, 40, 80, 160, 320, 640, 1280, 2560, 5120, 10240, 20480}, where 2^{μ}*15 kHz is the PRS sub-carrier spacing (SCS) and μ=0, 1, 2, or 3. Note that Tₚₑᵣ^{PRS}=2^{μ}·20480 is not supported for μ=0. Each PRS resource can also be repeated within Tᵣₑₚ^{PRS} times during one PRS resource set where Tᵣₑₚ^{PRS}∈{1, 2, 4, 6, 8, 16, 32}.

PRS are transmitted in L_{PRS} consecutive number of symbols within a slot, where L_{PRS}∈{2, 4, 6, 12}. The following DL PRS resource element (RE) patterns, with comb size K_{PRS} equal to number of symbols L_{PRS} are supported
Comb-2: Symbols {0, 1} have relative RE offsets {0, 1}
Comb-4: Symbols {0, 1, 2, 3} have relative RE offsets {0, 2, 1, 3}
Comb-6: Symbols {0, 1, 2, 3, 4, 5} have relative RE offsets {0, 3, 1, 4, 2, 5}
Comb-12: Symbols {0, 1, 2, 3, 4, 5, 6, 7, 8, 9, 10, 11} have relative RE offsets {0, 6, 3, 9, 1, 7, 4, 10, 2, 8, 5, 11}

Minimum and maximum PRS bandwidth (BW) is 24 and 272 PRBs, with the configured PRS BW always being a multiple of 4.

In general, a PRS resource set may include (or be define by) parameters such as SCS, PRS BW, PRS resource set periodicity and slot offset with respect to reference time (e.g., SFN #0, slot #0), PRS resource repetition factor (e.g., number of times PRS resource repeated in a PRS resource set), PRS symbols in a PRS resource, PRS resource time gap (e.g., number of slots between successive repetitions), PRS muting pattern, etc.

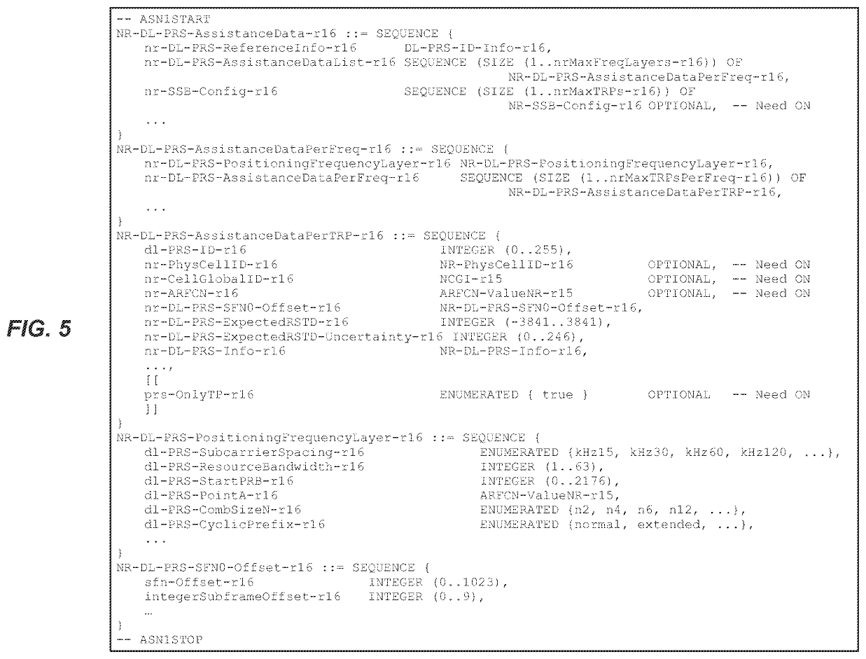

FIG. 5 shows an ASN.1 data structure for an exemplary NR-DL-PRS-AssistanceData IE that provides specific information about the DL-PRS that the UE should measure.

A UE can be configured to perform one or multiple type of positioning measurements on one or multiple cells, including any of the following:
Reference signal time difference (RSTD) between transmissions from node j and transmissions from reference node i. RSTD measurements always involve two cells (or TRPs such as in FIG. 4).
PRS reference signal received power (PRS-RSRP) is linear average over the power contributions (in Watts, W) of the resource elements that carry DL PRS reference signals.
PRS reference signal received path power (PRS-RSRPP) is the power of the received DL PRS signal configured for the measurement at the i-th path delay of the channel response, where DL PRS-RSRPP for Ist path delay is the power corresponding to the first detected path in time.
UE Rx-Tx time difference, a bidirectional timing measurement (or RTT) defined as T_{UE-RX}-T_{UE-TX}, where:
   T_{UE-RX} is the UE received timing of downlink subframe #i from a positioning node, defined by the first detected path in time. It is measured on PRS signals received from the gNB.
   T_{UE-TX} is the UE transmit timing of uplink subframe #j that is closest in time to the subframe #i received from the positioning node. It is measured on SRS signals transmitted by the UE.

A UE can also be configured for uplink transmission of sounding reference signals (SRS). The UE can be configured with one or more SRS resource sets with each SRS resource set including one or more SRS resources. Each SRS resource includes one or more symbols carrying SRS over a specified SRS BW. SRS can be configured as periodic, aperiodic, or semi-persistent transmissions. There are two additional options for SRS configuration; in both options the UE can be configured with 1, 2 or 4 antenna ports for transmitting each SRS resource (default is 1).

First, a UE can be configured with an SRS resource set in which each SRS resource occupies N_{S}∈{1, 2, 4} adjacent symbols within a slot. In this case, SRS antenna switching is supported. Each symbol can also be repeated with repetition factor R E {1,2,4}, where R≤Nₛ. The periodic SRS resource can be configured with a periodicity (T_{SRS}) from the set {1, 2, 4, 5, 8, 10, 16, 20, 32, 40, 64, 80, 160, 320, 640, 1280, 2560} slots.

Second, the UE can be configured with a positioning-specific SRS resource set, called SRS-PosResourceSet. In this case, each SRS positioning resource (SRS-PosResource) occupies N_{S}∈{1, 2, 4, 8, 12} adjacent symbols within a slot, and SRS antenna switching is not supported.

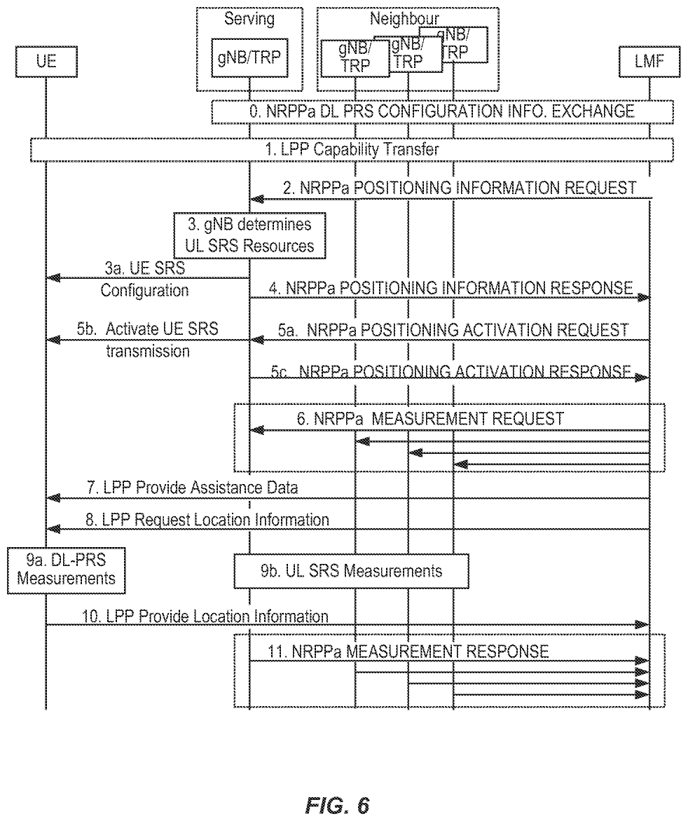

FIG. 6 shows a signal flow diagram for an exemplary multi-RTT positioning procedure between a UE, a serving gNB/TRP, a plurality of neighbor gNBs/TRPs, and an LMF. Further details are provided in 3GPP TS 38.305 (v16.2.0) section 8.10.4, the entirety of which is incorporated herein by reference. In this procedure, the UE measures DL-PRS transmitted by the respective gNBs/TRPs (operation 9a), which also measure UL-SRS transmitted by the UE (operation 9b). Note that other positioning methods may use similar signaling exchanges.

NR Rel-16 includes support for broadcasting of positioning assistance data via Positioning System Information Blocks (posSIBs), as specified in 3GPP TS 38.331 (v16.2.0). The posSIBs are carried in RRC System Information (SI) messages. The supported posSibTypes are shown in Table 1 below (also 3GPP TS 38.331 Table 7.2-1). The GNSS Common and Generic Assistance Data information elements (IEs) are defined in 3GPP TS 37.355 (v16.2.0) section 6.5.2.2. The OTDOA Assistance Data IEs and NR DL-TDOA/DL-AOD Assistance Data IEs are defined in 3GPP TS 37.355 section 7.4.2. The Barometric Assistance Data IEs are defined in 3GPP TS 37.355 section 6.5.5.8. The TBS (based on MBS signals) Assistance Data IEs are defined in 3GPP TS 37.355 section 6.5.4.8.

TABLE 1

| | posSibType | assistanceDataElement |
|---|---|---|
| GNSS Common | posSibType1-1 | GNSS-ReferenceTime |
| Assistance Data | posSibType1-2 | GNSS-ReferenceLocation |
| | posSibType1-3 | GNSS-IonosphericModel |
| | posSibType1-4 | GNSS- |
| | | EarthOrientationParameters |
| | posSibType1-5 | GNSS-RTK-ReferenceStationInfo |
| | posSibType1-6 | GNSS-RTK- |
| | | CommonObservationInfo |
| | posSibType1-7 | GNSS-RTK-AuxiliaryStationData |
| | posSibType1-8 | GNSS-SSR-CorrectionPoints |
| GNSS Generic | posSibType2-1 | GNSS-TimeModelList |
| Assistance Data | posSibType2-2 | GNSS-DifferentialCorrections |
| | posSibType2-3 | GNSS-NavigationModel |
| | posSibType2-4 | GNSS-RealTimeIntegrity |
| | posSibType2-5 | GNSS-DataBitAssistance |
| | posSibType2-6 | GNSS-AcquisitionAssistance |
| | posSibType2-7 | GNSS-Almanac |
| | posSibType2-8 | GNSS-UTC-Model |
| | posSibType2-9 | GNSS-AuxiliaryInformation |
| | posSibType2-10 | BDS-DifferentialCorrections |
| | posSibType2-11 | BDS-GridModelParameter |
| | posSibType2-12 | GNSS-RTK-Observations |
| | posSibType2-13 | GLO-RTK-BiasInformation |
| | posSibType2-14 | GNSS-RTK-MAC- |
| | | CorrectionDifferences |
| | posSibType2-15 | GNSS-RTK-Residuals |
| | posSibType2-16 | GNSS-RTK-FKP-Gradients |
| | posSibType2-17 | GNSS-SSR-OrbitCorrections |
| | posSibType2-18 | GNSS-SSR-ClockCorrections |
| | posSibType2-19 | GNSS-SSR-CodeBias |
| | posSibType2-20 | GNSS-SSR-URA |
| | posSibType2-21 | GNSS-SSR-PhaseBias |
| | posSibType2-22 | GNSS-SSR-STEC-Correction |
| | posSibType2-23 | GNSS-SSR-GriddedCorrection |
| | posSibType2-24 | NavIC-DifferentialCorrections |
| | posSibType2-25 | NavIC-GridModelParameter |
| OTDOA | posSibType3-1 | OTDOA-UE-Assisted |
| Assistance Data | | |
| Barometric | posSibType4-1 | Sensor-AssistanceDataList |
| Assistance Data | | |
| TBS | posSibType5-1 | TBS-AssistanceDataList |
| Assistance Data | | |
| NR DL-TDOA/ | posSibType6-1 | NR-DL-PRS-AssistanceData |
| DL-AoD | posSibType6-2 | NR-UEB-TRP-LocationData |
| Assistance Data | posSibType6-3 | NR-UEB-TRP-RTD-Info |

3GPP Rel-17 NR positioning enhancements include ongoing work for support of “on-demand PRS” in the network. This can involve two different scenarios or use cases. In a first scenario, on-demand PRS can involve configuring PRS on a per need basis, based on the pre-condition that no PRS are being transmitted. If an LCS client (e.g., GMLC, UE) requests positioning, the LMF needs to determine a suitable PRS configuration from scratch. A second scenario is where PRS is already being transmitted and either the UE may request or LMF may need to modify the current configuration.

The first scenario is similar to a scenario that already happens in real LTE PRS deployments: PRS is being transmitted but the LMF is unsure about the TRPs closest to UEs or cells to be included in the assistance data. In this case, E-CID is uses as a pre-requisite procedure to provide LMF the needed information. For on-demand PRS that are not currently being transmitted, the LMF may also request gNBs to perform E-CID to obtain SSB and CSI-RS RSRP measurements that can facilitate initiation of on-demand PRS transmissions.

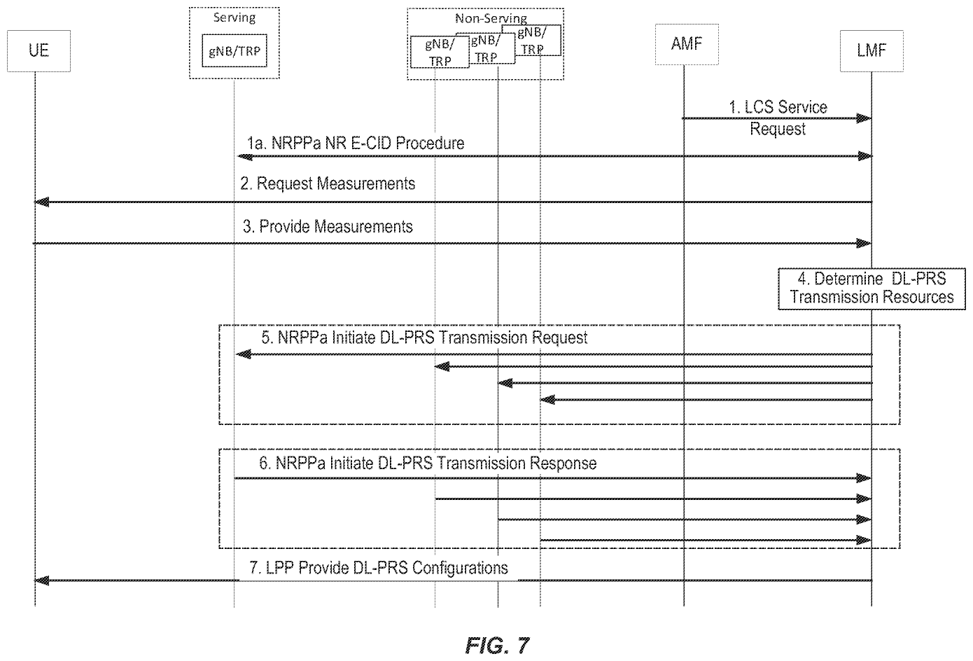

FIG. 7 shows an exemplary signaling procedure used to obtain a PRS configuration, in accordance with this scenario. Although certain operations are given numerical labels, these are intended to facilitate the following description rather than to imply or require any particular operational order.

In operation 1, the AMF transfers an LCS service request to an LMF. The LCS service request was received by the AMF from an LCS client residing in GMLC or UE. If the LCS client is in UE, it may include a measurement report (e.g., CSI-RS and SSB RSRP, E-CID report) as part of MO-LR request message. The UE's LCS client may also provide other details such as number of TRPs, beam direction, start time and duration for the DL-PRS transmission which may also be forwarded from AMF to LMF. In operation 1a, as an alternative, the LMF can receive a measurement report (e.g., CSI-RS and SSB RSRP) from the gNB as per the UL NR E-CID procedure defined in 3GPP TS 38.455. In operation 2, If the LCS client is the GMLC or the measurements are not available in operation 1, the LMF may request measurements from the UE. In operation 3, the UE provides the LMF with the measurements requested in operation 2.

In operations 4-5, the LMF determines the needed DL-PRS transmission resources and requests DL-PRS transmission from different gNBs (e.g., TRPs), which may include the UE's serving gNB(s) and other non-serving gNBs. In operation 6, the gNBs provide acknowledgement to the LMF for initiating the PRS transmission or may indicate failure if unable to initiate PRS transmission. In case of acknowledgement/success in operation 6, the LMF prepares the PRS configuration accordingly and provides to the UE in operation 7.

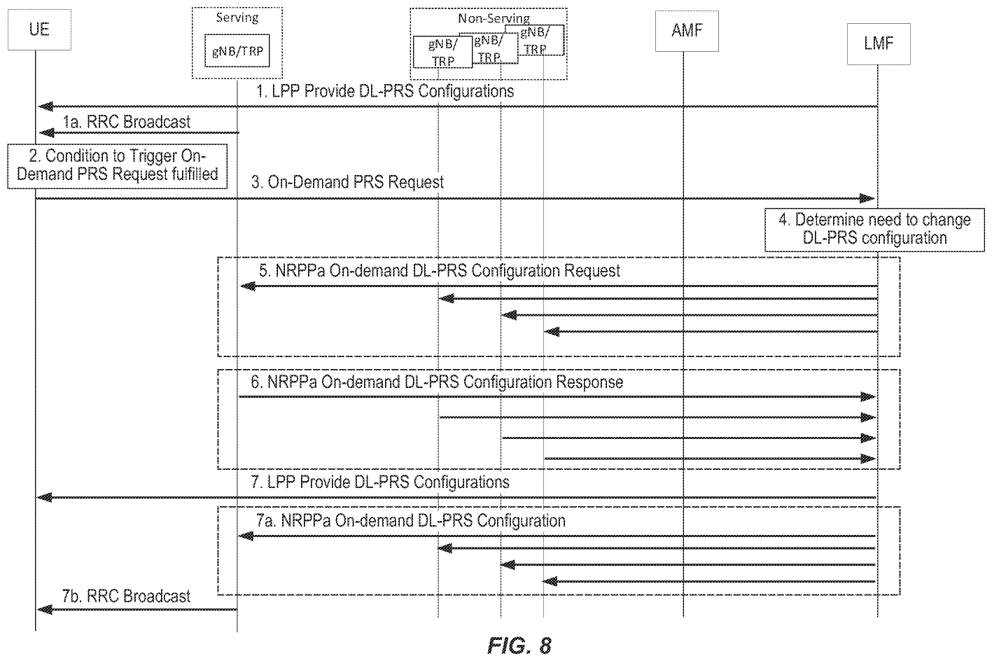

In the second scenario discussed above, when the LCS client wants to position the UE, certain DL-PRS are already being transmitted by the RAN. For example, there may be multiple pre-defined PRS configurations and UE may request one of the pre-defined configurations. Furthermore, the LMF may also change between different pre-defined PRS configurations. FIG. 8 shows an exemplary signaling procedure used to obtain a PRS configuration, in accordance with this scenario. Although certain operations are given numerical labels, these are intended to facilitate the following description rather than to imply or require any particular operational order.

In operation 1, the LMF provides a PRS configuration to the UE via LPP. Alternately or in addition, in operation 1a, the PRS configuration can be provided to UE via RRC broadcast. In operation 2, the UE performs positioning measurements based upon the PRS configuration(s) received in operation(s) 1/1a. If UE is operating in UE-based positioning mode and certain conditions such as PQOS are not met, or on the basis of measurement quality, confidence level, etc., the UE may determine the need to request on-demand PRS.

In operation 3, the UE sends an on-demand PRS request with its preferred configuration (e.g., configuration index) or a request to increase/decrease DL-PRS resources. In operation 4, the LMF determines whether there is need to change PRS configuration, as requested. The LMF may decide based upon input received from multiple UEs. In operation 5, based on the decision in operation 4, the LMF requests via NRPPa the serving and non-serving gNBs (e.g., TRPs) for the UE to change the current PRS configuration. In operation 6, the gNBs provide the PRS transmission update or an acknowledgement in an NRPPa response message accordingly.

In operation 7, the LMF provides the updated on-demand PRS configuration to the UE via LPP. Alternately or in addition, in operations 7a-7b, the LMF provides the on-demand PRS configuration to the gNBs, which provide the same to the UE via RRC broadcast.

In addition, predefined DL-PRS configurations have been discussed in 3GPP. For example, each pre-defined DL-PRS configuration can be associated with a different index and correspond to a different QoS, such as the examples below:
Index 1: Large BW, short periodicity, for high-accuracy and low-latency QoS
Index 2: Medium BW, medium periodicity, for QoS of medium accuracy and latency
Index 3: Low BW, large periodicity, for low-accuracy and high-latency QoS

One of the objectives of 3GPP Rel-17 is to reduce positioning latency, and several features have been introduced to address this objective. One example is storing UE positioning capability in the AMF, from which the LMF can obtain more quickly than from the UE. Another example is a scheduled location time, T (e.g., desired by LCS client) for which the LMF configures the UE the necessary actions (e.g., measure PRS) in advance. Another example is moving positioning-related signaling from RRC to MAC layer, such as MAC CE-based Gap activation/deactivation that is estimated to reduce latency ˜10 ms.

As briefly mentioned above, when a UE is in RRC_IDLE or RRC_INACTIVE modes, the UE's radio is active on a DRX schedule configured by the network via RRC. During DRX active times (also referred to as “DR.X On durations”), the UE receives SI broadcast in the cell where the UE is camping, performs measurements of neighbor cells to support cell reselection, and monitors a paging channel on PDCCH for pages from 5GC via gNB. During DRX inactive times (also referred to as “DRX Off durations”), the UE enters a low-energy state.

The amount of UE energy savings is related to DRX On duration as a fraction of the DRX cycle length (T_{DRX}). Example DRX cycle lengths used in RRC_IDLE and RRC_INACTIVE states include 320 ms, 640 ms, 1.28 s, 2.56 s, etc. In these RRC states, the DRX may also be referred to as a paging cycle, in which the UE has a configured number of paging occasions (POs) per DRX cycle to wake up and receive paging.

In RRC_CONNECTED state, a UE monitors PDCCH for scheduling of UL/DL data transmissions (i.e., on PDSCH and physical UL shared channel (PUSCH), respectively) and for other purposes. In between these monitoring occasions, the UE can go to sleep to reduce energy consumption. This sleep-wake cycle in RRC_CONNECTED mode is also known as DRX or alternately connected DRX (C-DRX) to distinguish it from DRX in RRC_IDLE and RRC_INACTIVE described above. Like in these state, the amount of UE energy savings in RRC_CONNECTED is related to DRX on duration as a fraction of the DRX cycle length.

A UE can be configured with a UE-specific DRX (or C-DRX) cycle or a cell-specific DRX (or C-DRX) cycle. According to 3GPP TS 24.501 (v17.4.1), the UE can be configured with DRX cycle by the 5GC (e.g., AMF) using non-access stratum (NAS) signaling. According to 3GPP TS 24.501 section 8.2.6.15, if the UE wants to use or change the UE-specific DRX parameters, the UE shall include a Requested DRX parameters IE in a REGISTRATION REQUEST message sent to the 5GC.

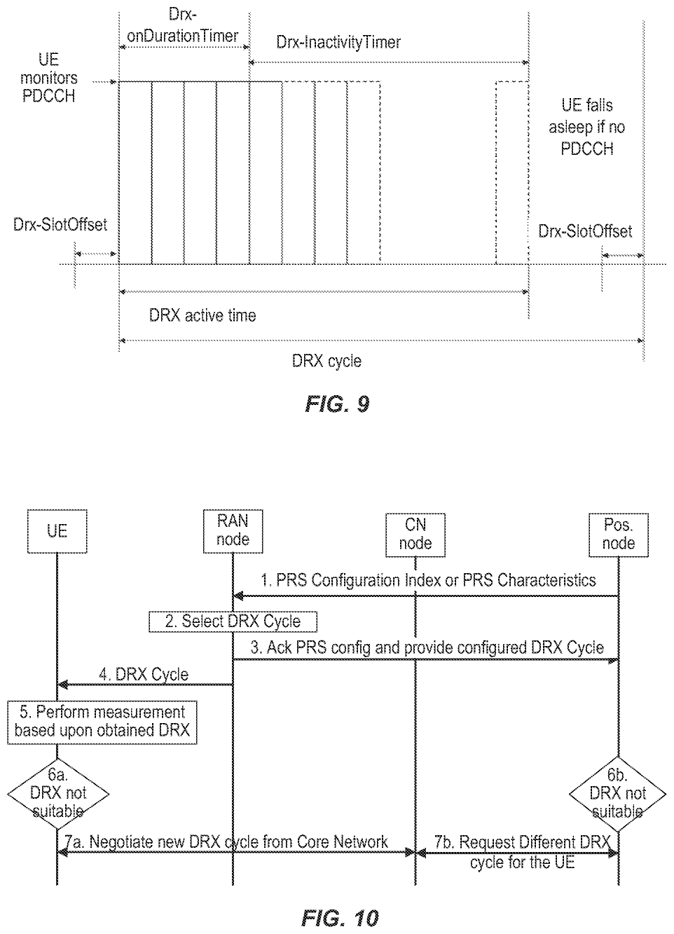

FIG. 9 shows a timing diagram that illustrates exemplary C-DRX operation, which will be referred to as DRX for brevity. The network configures UE DRX parameters and DRX operational mode (e.g., Short DRX and/or Long DRX, a scheme in which initially a short and faster cyclic pattern occurs). At a high level, if the UE successfully decodes a PDCCH, the UE stays awake and starts an inactivity timer supervising a switch back to DRX. If no DCI is received while the inactivity timer is running, UE directly switch to sleep.

In more detail, CDRX operation is based on a DRX cycle, a DRX active time, a DRX-onDurationTimer, a DRX-slotOffset, and a DRX-inactivityTimer. There are defined as follows:
DRX-onDurationTimer: duration at the beginning of a DRX cycle me during which UE waits to receive PDCCH after waking up from DRX. The on duration is a periodic phase which reoccurs with each start of a DRX cycle. This phase defines the minimum average awake time of a UE and can be configured (via RRC) from 1 to 1600 ms. There is only one DRX-onDurationTimer regardless of the DRX operational mode configured at any given time.
DRX-slotOffset: delay from the beginning of a subframe before UE starts the DRX-onDurationTimer. This value can be configured from 0 to 31.
DRX-InactivityTimer(s): duration after occasion in which a PDCCH indicates a new UL or DL transmission for the UE MAC entity. The UE starts the first inactivity timer supervising the switch to DRX when it successfully decodes PDCCH for an initial transmission (not for retransmissions). If short DRX is configured, the UE starts the inactivity timer supervising the switch from short DRX cycles to long DRX cycles when it enters DRX (i.e., at expiry of the first inactivity timer). According to 3GPP TS38.331, this time value can be configured from 0 to 2560 ms. If the UE receives a valid DCI while the DRX-inactivity Timer is running, it extends the timer and continues to monitor PDCCH. If the DRX-inactivityTimer expires, the UE stops PDCCH monitoring and goes to sleep until the end of the current DRX cycle.
DRX active time: The total time during which the UE is awake and monitoring PDCCH, i.e., the duration from the beginning of the DRX on duration until inactivity timer expiration. The minimum active time is equal to the DRX-onDurationTimer value and the maximum is undefined (e.g., infinite).
DRX cycle: The total time of DRX active time and UE sleep time. This is also configurable, e.g., as a trade-off value between reduced UE energy consumption and UE delay requirements. For long DRX cycle this value can vary from 10 to 10240 ms, and for short DRX cycle this value can vary from 2 to 640 ms.

UE energy consumption generally varies linearly with the DRX active time, e.g., as a fraction of the DRX cycle. However, reducing the energy consumption by increasing the DRX cycle comes with a cost of delaying the UE's wake-up from sleep, which will increase latency for network-initiated transactions such as paging and handover. Additionally, the performance of all delay-sensitive applications will degrade as the length of DRX sleep increases.

Positioning latency is an important factor for various positioning applications. Table 2 below from 3GPP TR 38.857 (v17.0.0) shows the components of positioning latency, of which a large part is due to UE measurement latency.

TABLE 2

| | | |
|---|---|---|
| | Latency | |
| Label | [ms] | Description |

Processing Latencies

| | | |
|---|---|---|
| T_{UEProc-RRCReconf} | 10 | RRC Reconfiguration processing |
| T_{UEProc-RRCDLInfo} | 5 | RRC DL information transfer |
| T_{UEProc-RRCULInfo} | 2-5 | RRC UL information transfer |
| T_{UEProc-RRCLocationMeas} | 2-5 | RRC Location Measurement Indication |
| T_{UEProc-LPPCapab} | 10-20 | LPP Provide Capabilities |
| T_{UEProc-LPPAssi} | 10 | LPP Provide Assistance Data |
| T_{UEProc-LPPLocationRe} | 5 | LPP Request/Provide Location |
| | | Information |
| T_{UEProc-MAC-SRSAct} | 1-3 | MAC-CE SRS Activation/Deactivation |
| T_{gNBProc-RRC} | 3 | RRC Processing |
| T_{gNBProc-NRPPa} | 3 | NRPPa Processing |
| T_{gNBProc-NAS/LPP} | 3 | NAS/LPP Processing |
| T_{AMFProc} | 3 | AMF Processing |
| T_{LMFProc} | 3 | LMF Processing |

Signaling Propagation Delays between Nodes

| | |
|---|---|
| T_{UE-gNB} | 0-0.5 |
| T_{gNB-AMF} | 3-10 |
| T_{AMF-LMF} | 1-10 |
| T_{AMF-GMLC} | 3-10 |

Positioning Measurement Latencies

| | | |
|---|---|---|
| T_{LMF-Calc} | 2-30 | Position Calculation latency |
| T_{DL-Meas} | 88.5 | Estimated minimum DL PRS |
| | | measurement time in Rel- 16 can be |
| | | 88.5 ms depending on DL PRS |
| | | configuration. |
| T_{UL-Meas} | 12 | SRS for positioning measurement time |
| | | of 12 ms can be achieved under certain |
| | | SRS for positioning configuration |
| | | depending on frame configuration. |

A UE is expected to perform positioning measurements not only in RRC_CONNECTED but also in RRC_INACTIVE where the positioning measurement period is function of the DRX cycle. As mentioned above, an RRC_INACTIVE UE can be configured with DRX cycle between 320 ms and 2.56 seconds. Therefore, the UE positioning measurement period (i.e., TDL-Meas in Table 2 above) may become very long as will the overall latency in determining the UE location. This in turn can degrade the positioning accuracy, particularly if the UE is moving during the long positioning measurement period.

Accordingly, embodiments of the present disclosure provide flexible and efficient techniques for providing UE DRX configurations that are specific to and/or compatible with PRS configurations used by the UE. For example, if a PRS configuration has PRS resources with short periodicity, then a short DRX cycle is configured to facilitate PRS measurements with low latency. Likewise, if a PRS configuration has PRS resources with longer periodicity, then a longer DRX cycle can be configured accordingly to facilitate UE energy savings. Table 3 below shows an illustrative example of UE DRX configurations arranged in this manner.

TABLE 3

| PRS | | | | |
|---|---|---|---|---|
| Index | QoS Requirement | PRS Characteristics | DRX Cycle | |
| 1 | High-accuracy and | a configuration with large | 1.28 | s |
| | low-latency | bandwidth and short | | |
| | positioning | periodicity | | |
| 2 | Medium accuracy and | a configuration with | 2.56 | s |
| | latency positioning | medium bandwidth and | | |
| | | periodicity | | |
| 3 | Low-accuracy and | a configuration with small | 10.24 | s |
| | high-latency | bandwidth and large | | |
| | positioning | periodicity | | |

Embodiments can provide various benefits, advantages, and/or solutions to problems described herein. For example, embodiments allow a network to provide UE DRX configurations that are specific to and/or compatible with PRS configurations used by the UE, such as a UE-selected one of multiple predefined PRS configurations. In this manner, embodiments provide an improved and/or optimal tradeoff between positioning latency and UE energy consumption.

Embodiments are described below in the context of the following scenario. A UE is served by at least a first cell (cell1), which is served, managed, or provided by a first network node (NN1, e.g., base station, gNB, eNB, ng-eNB, etc.). In some cases, the UE may be configured to operate in non-connected state such as RRC_INACTIVE, RRC_IDLE, or states with similar properties of low UE activity with reduced energy consumption. The UE is configured by a DRX cycle in this non-connected state (e.g. extended DRX)). For example, the UE is configured with a cell-specific DRX cycle by receiving a SI message (e.g., SIB) broadcast from cell1. Alternately, the UE may be configured with a UE-specific DRX cycle via a NAS message from a second network node (NN2, e.g., AMF, MME, etc.).

In the example scenario, the UE may be configured by a third network node (NN3, e.g., LMF, E-SMLC, etc.) to perform one or more positioning measurements (e.g., RSTD, PRS-RSRP, PRS-RSRPP, UE Rx-Tx time difference etc.) on DL RS (e.g., PRS) transmitted on one or more positioning frequency layers (PFL, e.g., carrier, carrier frequency, frequency layer, etc.) in one or more cells. The UE may also be configured to transmit UL RS (e.g., SRS) that can be measured by network nodes (e.g., NN1). The UE performs the positioning measurement over a measurement period (Tm), which can be a function of the UE's configured DRX cycle.

Note that a PFL may be a frequency of a component carrier (CC) in a serving cell (e.g., PCC, SCC, PSC, etc.) or a non-serving carrier frequency (e.g., inter-frequency carrier, inter-RAT carrier, etc.). Note that in some cases NN3 can be the same as NN1, i.e., serving NN1 can configure the UE to perform the positioning measurements.

In general, pre-defined PRS configurations are determined and provided by LMF. Subsequently, a UE, a gNB, or the LMF may select one of the pre-defined PRS configurations depending on pQoS target. The selection can also depend on cell-specific conditions, e.g., number of UEs present in the cells, number of TRPs deployed, radio conditions in the cells, etc. These conditions are generally known by the gNBs but not by the LMF.

A principle of the techniques described herein is a mapping or association from a DRX cycle (e.g., configured by gNB and/or AMF) to a PRS configuration (e.g., configured by LMF), or vice versa. For example, an LMF may recommend whether short or long DRX cycle is preferrable for a particular PRS configuration, or it may recommend a specific DRX cycle (e.g., 1.28 s or 2.56 s). Even so, the gNB transmits PRS and thus is aware of any pre-defined configuration (or other characteristics) associated with PRS that it is transmitting. As such, the gNB may also provide to the UE a UE- or cell-specific DRX cycle that matches or aligns with the configuration and/or characteristics of the transmitted PRS, upon the UE entering RRC_INACTIVE state.

Embodiments will now be described in more detail, with reference to first, second, third, and fourth groups. Even so, this nomenclature is used to facilitate description and does not imply any ordering of the embodiments. Furthermore, embodiments of the different groups may be used cooperatively and/or advantageously.

In a first group of embodiments, a UE determines a suitable PRS configuration based on an association or mapping between two or more PRS configurations and their respective sets of DRX cycles, as well as the UE's configured DRX cycle. For example, the UE can select one of the PRS configurations that is associated with the UE's configured DRX cycle. The selected PRS configuration enables the UE to meet its pQOS (pQOS) target. The UE further uses the selected PRS configuration for performing one or more positioning measurements, and may further use the positioning measurement results for performing one or more operational tasks (e.g., determining UE position, transmitting positioning measurements and/or position to a network node, etc.).

In some embodiments, the selected PRS configuration includes one or more parameters implicitly or explicitly related to PRS, such as PRS BW, PRS resource periodicity, number of PRS resources in PRS resource sets, number of cells or TRPs on which the positioning measurement is to be performed by the UE, etc. As discussed above, the PRS configuration is transmitted by NN3 (e.g., LMF) to the UE via PRS assistance data. The UE selects or determines the suitable PRS configuration based on one or more rules that may be pre-defined or configured by NN1, NN2, NN3, etc. Some exemplary PRS configuration selection (or determination) rules are discussed below.

Examples of parameters defining pQOS include positioning measurement period (e.g., RSTD measurement period), positioning measurement accuracy (e.g., RSTD accuracy such as within ±X1 Tc, where Tc≈0.5 ns), UE positioning accuracy (e.g., within +X2 meters), UE positioning latency (e.g., time period to acquire UE position), etc. The pQOS target may depend on the positioning purpose. For example, the pQOS target may be higher during critical operations (e.g., emergency call, earthquake, fire) compared to pQoS targets during non-critical operations (e.g., personal navigation, commercial, etc.). For example, any operation that is not classified as critical can be classified as non-critical.

In some embodiments, a UE may be implicitly or explicitly configured to meet certain pQOS target(s), such as by meeting one or more criteria or conditions associated with the pQos target. Some example criteria or conditions include positioning measurement period is less than a first threshold, positioning delay is less than a second threshold, positioning measurement accuracy is within a first range, positioning accuracy is within a second range, etc.

In a first example PRS configuration selection rule, the UE obtains at least two sets of PRS configurations that are associated with or mapped to respective sets of DRX cycles. The UE may obtain the association or mapping from the network (e.g., NN3) in positioning assistance data. The UE then selects a particular one of the PRS configurations that is associated with or mapped to the DRX cycle configured for the UE.

Table 4 illustrates a general example of an association or mapping between N sets of PRS configurations (PRS₁, PRS₂, . . . . PRS_{N}) and corresponding N sets of DRX cycles (DRX₁, DRX₂, DRX_{N}). Each set of DRX cycles includes at least one DRX cycle, with only one per set shown . . . in Table 4. Table 5 illustrates a specific example of four (4) sets of PRS configurations and corresponding four (4) DRX cycles, also with only one per set. Table 6 illustrates another specific example in which each set of DRX cycles includes all valid values within a particular range. The selection rule in Table 6 may be used, for example, when the network is not aware of the UE DRX cycle and/or when the network is aware of the UE pQoS target.

TABLE 4

| Set | PRS configuration | DRX cycle set |
|---|---|---|
| 1 | PRS₁ | DRX₁ |
| 2 | PRS₂ | DRX₂ |
| . . . | . . . | . . . |
| N | PRS_{N} | DRX_{N} |

TABLE 5

| Set | PRS configuration | DRX cycle [ms] |
|---|---|---|
| 1 | PRS₁ | 320 |
| 2 | PRS₂ | 640 |
| 3 | PRS₃ | 1280 |
| 4 | PRS₄ | 2560 |

TABLE 6

| Set | PRS configuration | DRX cycle range [ms] |
|---|---|---|
| 1 | PRS₁ | 320 ≤ T_{DRX} < 1280 |
| 2 | PRS₂ | 1280 ≤ T_{DRX} ≤ 2560 |

In a second example PRS configuration selection rule, the UE obtains at least two sets of PRS configurations (PRS₁, PRS₂, . . . . PRS_{N}) that are associated with or mapped to a single set of DRX cycles (DRXs) and to respective N sets of PQOS targets (pQoS1, pQos2, . . . pQoSN). The DRX cycle configured for the UE belongs to DRXs. The UE may obtain the association or mapping from the network (e.g., NN3) in positioning assistance data. The UE then selects a particular one of the PRS configurations that is associated with or mapped to the pQoS target that the UE must meet.

Table 7 below shows a general example of an association or mapping between N set of PRS configurations (PRS₁, PRS₂, . . . . PRS_{N}) and corresponding N sets of PQOS targets (pQoS1, pQos2, . . . pQoSN). Each pQOS set may include one or more pQoS targets. Table 8 shows a specific example of two (2) PRS configurations that are mapped to two (2) sets of pQoS targets, with each set including two (2) pQoS targets. In another variant, each pQoS set may be defined by a pQoS range. This variant may be used for example when the network is aware of the UE DRX cycle and/or when the network is not aware of the pQoS target for the UE but may be aware that the pQoS target belongs to a particular set that includes multiple pQoS targets.

TABLE 7

| Set | PRS configuration | DRX cycle set | pQoS set |
|---|---|---|---|
| 1 | PRS₁ | DRX_{S} | pQoS₁ |
| 2 | PRS₂ | | pQoS₂ |
| . . . | . . . | | . . . |
| N | PRS_{N} | | pQoS_{N} |

TABLE 8

| Set | PRS configuration | DRX cycle set | pQoS set |
|---|---|---|---|
| 1 | PRS₁ | DRX_{S} | {pQoS₁₁, pQoS₁₂} |
| 2 | PRS₂ | | {pQoS₂₁, pQoS₂₂} |

In some embodiments, the UE can receive the positioning assistance including the association or mapping from the network node (e.g., NN3) in an unsolicited manner. In other embodiments, the UE may send a request to the network node for the positioning assistance when one or more conditions are met. An example condition is when the UE cannot meet its pQoS based on an existing (or legacy) PRS configuration. In some embodiments, the UE can send the network node an indication of the selected PRS configuration, which can be done proactively or upon request from the network node.

In a second group of embodiments, a UE can determine whether it can meet a given pQos target based on the DRX cycle and the PRS configuration that have been provided (i.e., configured) to the UE by the network. The UE then performs one or more tasks based on the result of this determination. For example, when the UE determines that it cannot meet its pQoS target, the UE can request the network (e.g., AMF, gNB) to reconfigure its DRX cycle such that the UE can meet the pQoS target. On the other hand, when UE determines that it can meet its pQoS target, the UE performs or continue performing the ongoing positioning measurements based on the UE's PRS configuration and the UE's configured DRX cycle. The UE may also use the positioning measurement results for performing one or more operational tasks, such as determining the UE positioning and/or transmitting the positioning measurement results to a network node.

In some embodiments, the UE can determine whether it can meet the pQoS target based on one or more criteria. The determination criteria can be pre-defined or configured by the network (e.g., NN1, NN2, NN3, etc.).

In one example of determination criteria, the UE may determine whether it can meet the pQOS based on an association or mapping of the UE's PRS configuration and/or the UE's configured DRX cycle to a corresponding pQoS. The association or mapping can be autonomously determined by the UE, pre-defined, or configured by a network node. For example, the UE can use any of the associations or mappings shown above in Tables 7-8.

In some embodiments, when the UE determines that it can meet its pQoS target based on the UE's PRS configuration and the UE's configured DRX cycle, then the UE performs positioning measurements continues performing the ongoing positioning (if already started) using the UE's PRS configuration and the UE's configured DRX cycle.

In some embodiments, when the UE determines that it cannot meet its pQoS target based on the UE's PRS configuration and/or the UE's configured DRX cycle (e.g., 2560 ms), then the UE requests a network node (e.g., NN1, NN2, NN3 etc.) to change or modify the UE's DRX cycle. The request message may include one or more DRX cycles (e.g., 1280 ms) or ranges of DRX cycles (e.g., 320-1280 ms) that are preferred or recommended by the UE in order to meet the pQoS target. In some embodiments, the request message may include a reason for change or modification.

In response, the network node may reconfigure the UE with one of the DRX cycles indicated in the request, or with a DRX cycle that is similar (e.g., slightly shorter in duration) to one of the DRX cycles indicated in the request. In different embodiments, during the time period in which the DRX cycle is being modified, the UE can suspend or continue performing the positioning measurement.

In other embodiments, when the UE determines that it cannot meet its pQoS target based on the UE's PRS configuration and/or the UE's configured DRX cycle, then the UE stops performing the positioning measurements and does not request the network node to modify the UE's DRX cycle. For example, the UE may behave in this manner when it is configured with a DRX cycle shorter than a threshold and/or the shortest possible DRX cycle in the UE's current RRC state (e.g., 320 ms in RRC_INACTIVE).

In some variants, the UE may discard the positioning measurement results if the UE has partially or fully performed the measurement. In other variants, the UE does not discard the positioning measurement results and transmits them to a network node (e.g., NN3/LMF). The UE may also inform the network node that the UE has stopped performing the positioning measurements and, in some cases, the reason for stopping the positioning measurements.

FIG. 10 shows a signal flow diagram of a procedure between a UE, a RAN node (e.g., gNB), a CN node (e.g., AMF), and a positioning node (e.g., LMF), according to some embodiments of the second group. Although the operations shown in FIG. 10 are given numerical labels, this is done to facilitate explanation and neither implies nor requires any particular order of the numbered operations, unless expressly stated to the contrary below.

In operation 1, the positioning node requests the RAN node to transmit DL-PRS with certain characteristics or according to some pre-defined PRS Configuration Index (e.g., as discussed above). In some embodiments, the positioning node's request may include an indication of one or more recommended and/or preferred DRX cycles for the UE.

In operation 2, the RAN node determines suitable Cell specific DRX cycle for the PRS Configuration with certain characteristics or pre-define DL-PRS configuration. RAN node may also configure suitable UE-specific RRC_INACTIVE DRX cycle if it happens to know that certain UE is going to perform PRS measurement in RRC_INACTIVE or RRC_IDLE.

In operation 3, the RAN node confirms to the positioning node whether the positioning node's request was accepted and, when accepted, the RAN node provides the UE's configured DRX cycle to the positioning node. In operation 4, the RAN node provides the configured DRX to the UE via broadcast or dedicated signaling. In operation 5, the UE performs positioning measurements using the configured DRX according to the DL-PRS configuration.

In operation 6, the UE (operation 6a) and/or the positioning node (operation 6b) identifies that the configured DRX is not appropriate (e.g., latency pQoS requirements are not met). In operation 7, the UE (operation 7a) and/or the positioning node (operation 7b) negotiates a UE-specific DRX cycle with the CN node. In the case of positioning node negotiation (operation 7b), the CN node may then provide the DRX cycle to the UE.

In a third group of embodiments, a network node (e.g., NN3/LMF) selects a suitable PRS configuration based on the UE's configured DRX cycle, and configures the UE with the selected PRS configuration. The network node selects the suitable PRS configuration based on an association or mapping between two or more PRS configurations and their respective sets of DRX cycles. The association or mapping may be implicitly or explicitly related to a set of pQoS targets, such that the selected PRS configuration enables the UE to meet its pQoS target.

In some embodiments, the network node (e.g., NN3/LMF) obtains information about the UE's configured DRX cycle from another network node (e.g., NN1/gNB, NN2/AMF, etc.) that serves the UE in some manner. The network node determine the PRS configuration (e.g., selects from a pre-defined set of DL-PRS configurations) that enables the UE to meet its pQoS target. The network node then configures the UE with the determined PRS configuration, e.g., via positioning assistance data. For example, the network node (e.g., NN3) may determine the PRS configuration based on the UE's configured DRX cycle using the same or similar rules as described above in relation to the first and second groups of embodiments.

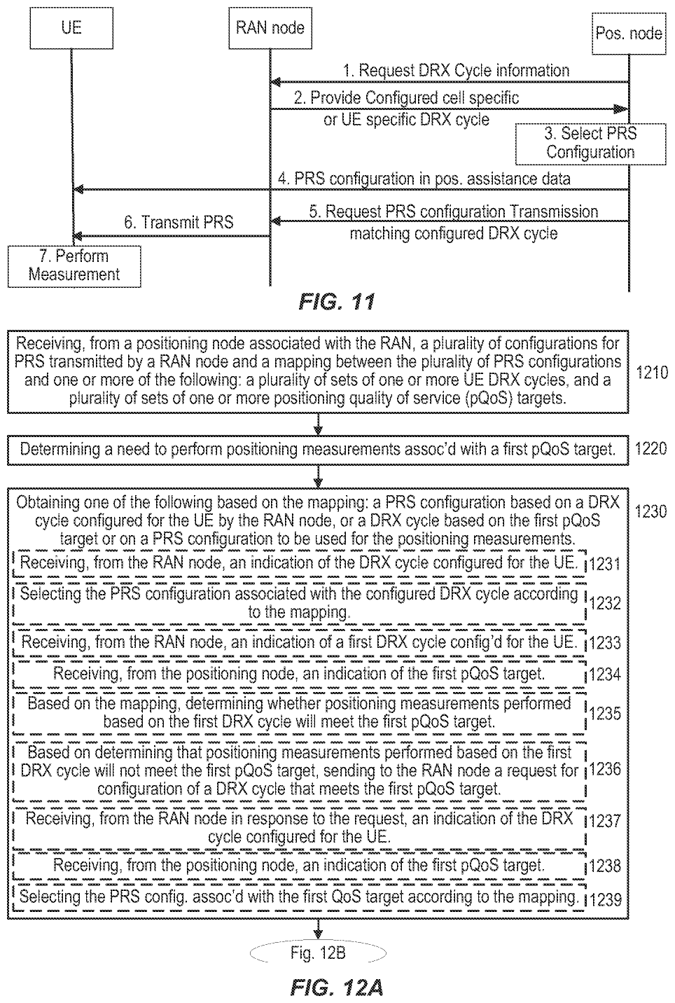

FIG. 11 shows a signal flow diagram of a procedure between a UE, a RAN node (e.g., gNB), and a positioning node (e.g., LMF), according to some embodiments of the third group. Although the operations shown in FIG. 11 are given numerical labels, this is done to facilitate explanation and neither implies nor requires any particular order of the numbered operations, unless expressly stated to the contrary below.

In operation 1, the positioning node requests DRX cycle information for the UE from the RAN node, which serves the UE in a cell. In operation 2, the RAN node provides an indication of a UE- or cell-specific DRX cycle configured for the UE. In operation 3, the positioning node selects a PRS configuration based on the UE's configured DRX cycle. In operation 4, the positioning node configures the UE with the selected PRS configuration, e.g., by sending positioning assistance data such as discussed above. In operation 5, the positioning node requests the RAN node to transmit PRS in the cell according to the selected PRS configuration, which aligns with the UE's configured DRX cycle in the cell. In operations 6-7, the RAN node transmits the PRS and the UE performs positioning measurements on the received PRS.

In a fourth group of embodiments, a network node (e.g., NN1/gNB) serving the UE obtains information about the UE's PRS configuration, selects a suitable DRX cycle for the UE based on the obtained information, and configures the UE with the selected DRX cycle. The network node (e.g., gNB) selects the suitable PRS configuration based on an association or mapping between a set of PRS configurations and corresponding sets of DRX cycles. The association or mapping May be implicitly or explicitly related to a set of pQoS targets, such that the selected DRX cycle enables the UE to meet its pQoS target. For example, the network node (e.g., NN1) may select the DRX cycle based on the UE's PRS configuration using the same or similar rules as described above in relation to the first and second groups of embodiments.

In some example, the network node receives information about the UE's PRS configuration from another network node (e.g., NN3/LMF) that is responsible for setting and/or providing the UE's PRS configuration. For example, NN3 (e.g., LMF) can provide via NRPPa signaling a DL-PRS configuration index corresponding to UE's PRS configuration. In some cases, NN3 may also provide an indication of one or more recommended DRX cycles associated with the UE's PRS configuration. In such cases, the network node can select the suitable DRX cycle from among the recommended DRX cycles.

Alternately, the network node serving the UE determines the UE's PRS configuration based on cross-layer acquisition/interpretation of a message from NN3 that includes positioning assistance data with the UE's PRS configuration. For example, the network node may read an LPP message from LMF that contains the UE's PRS configuration.

In one specific implementation example, an LMF may provide DL-PRS assistance data for broadcast in a cell served by the gNB (e.g., in a positioning SIB). The gNB reads the included PRS configuration, selects a suitable DRX cycle associated with the PRS configuration, and appends the selected DRX cycle to the positioning SIB for broadcast in the cell.

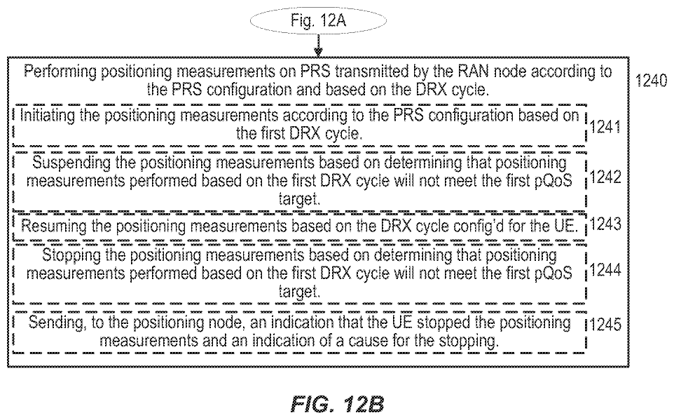

Various features of the embodiments described above correspond to various operations illustrated in FIGS. 12-14, which show exemplary methods (e.g., procedures) for a UE, a positioning node, and a RAN node, respectively. In other words, various features of the operations described below correspond to various embodiments described above. Furthermore, the exemplary methods shown in FIGS. 12-14 can be used cooperatively to provide various benefits, advantages, and/or solutions to problems described herein. Although FIGS. 12-14 show specific blocks in particular orders, the operations of the exemplary methods can be performed in different orders than shown and can be combined and/or divided into blocks having different functionality than shown. Optional blocks or operations are indicated by dashed lines.

In particular, FIG. 12 (which includes FIGS. 12A-B) shows an exemplary method (e.g., procedure) for a UE for positioning in a RAN, according to various embodiments of the present disclosure. The exemplary method can be performed by a UE (e.g., wireless device, etc.) such as described elsewhere herein.

The exemplary method can include the operations of block 1210, where the UE can receive, from a positioning node, a plurality of configurations for positioning reference signals (PRS) transmitted by a RAN node and a mapping between the plurality of PRS configurations and one or more of the following: a plurality of sets of one or more UE discontinuous reception (DRX) cycles, and a plurality of sets of one or more positioning quality of service (pQoS) targets.

The exemplary method can also include the operations of block 1230, where the UE can obtain one of the following based on the mapping:
a PRS configuration based on a DRX cycle configured for the UE by the RAN node; or
a DRX cycle based on a first pQoS target or on a PRS configuration to be used for positioning measurements.

The exemplary method can also include the operations of block 1240, where the UE can perform positioning measurements on PRS transmitted by the RAN node according to the PRS configuration and based on the DRX cycle.

In various embodiments, the exemplary method can also include the operations of block 1220, where the UE can determine a need to perform positioning measurements associated with a first pQoS target.

In various embodiments, the plurality of configurations can be differentiated from each other based on one or more of the following characteristics or parameters:
PRS transmission periodicity;
PRS transmission bandwidth;
PRS resource repetition factor;
PRS symbols in PRS resource;
PRS muting pattern;
PRS subcarrier spacing;
PRS resource set periodicity and slot offset;
PRS resource time gap
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

In some embodiments, each pQoS target is associated with one or more of the following: an accuracy criterion, and a latency criterion. In some of these embodiments, the plurality of PRS configurations include:
a first PRS configuration associated with a high accuracy criterion and a low latency criterion;
a second PRS configuration associated with a medium accuracy criterion and a medium latency criterion; and
a third PRS configuration associated with a low accuracy criterion and a high latency criterion.

Table 3 above shows an example of these embodiments.

In some embodiments, the mapping includes the following:
an explicit mapping between the plurality of PRS configurations and the respective plurality of sets of DRX cycles, and
an implicit mapping between the plurality of PRS configurations and a corresponding plurality of pQoS targets, based on the DRX cycles included in the respective sets.

Tables 4-6 show examples of these embodiments.

In some of these embodiments, obtaining based on the mapping in block 1230 can include the operations of sub-blocks 1231-1232, where the UE can receive, from the RAN node, an indication of the DRX cycle configured for the UE and select the PRS configuration associated with the configured DRX cycle according to the mapping.

In other of these embodiments, obtaining based on the mapping in block 1230 can include the operations of sub-blocks 1233-1235, where the UE can receive, from the RAN node, an indication of a first DRX cycle configured for the UE; receive, from the positioning node, an indication of the first pQoS target; and based on the mapping, determine whether positioning measurements performed based on the first DRX cycle will meet the first pQoS target.

In some variants, obtaining based on the mapping in block 1230 can also include the operations of sub-blocks 1236-1237, where the UE can, based on determining that positioning measurements performed based on the first DRX cycle will not meet the first pQoS target, send to the RAN node a request for configuration of a DRX cycle that meets the first pQoS target; and receive, from the RAN node in response to the request, an indication of the DRX cycle configured for the UE. Although shown as a separate sub-block, the operations of block 1235 can also correspond to the operations of sub-block 1231, discussed above.

In some further variants, the request includes an indication one or more recommended DRX cycles that facilitate UE positioning measurements that meet the first pQoS target. In some further variants, the DRX cycle configured for the UE is less than the first DRX cycle. In some further variants, performing the positioning measurements in block 1240 includes the operations of sub-blocks 1241-1243, where the UE can initiate the positioning measurements according to the PRS configuration based on the first DRX cycle, suspend the positioning measurements based on determining that positioning measurements performed based on the first DRX cycle will not meet the first pQoS target, and resume the positioning measurements based on the DRX cycle configured for the UE.

In other of these embodiments, performing the positioning measurements in block 1240 includes the operations of sub-blocks 1241 and 1244-1245, where the UE can initiate the positioning measurements according to the PRS configuration based on the first DRX cycle, stop the positioning measurements based on determining that positioning measurements performed based on the first DRX cycle will not meet the first pQoS target, and send to the positioning node an indication that the UE stopped the positioning measurements and an indication of a cause for the stopping. In some variants, stopping the positioning measurements is further based on determining that the first DRX cycle is one or more of the following: less than a threshold, or a shortest available DRX cycle for the UE's RRC state with respect to the RAN node.

In other embodiments, the mapping includes:
a first mapping between the plurality of PRS configurations and a corresponding plurality of sets of pQoS targets; and
a second mapping of a single set of DRX cycles to all of the PRS configurations and to all of the sets of pQoS targets.

Tables 7-8 show examples of these embodiments. In some of these embodiments, obtaining based on the mapping in block 1230 includes the operations of sub-blocks 1238-1239, where the UE can receive from the positioning node an indication of the first pQOS target and select the PRS configuration associated with the first QoS target according to the mapping.

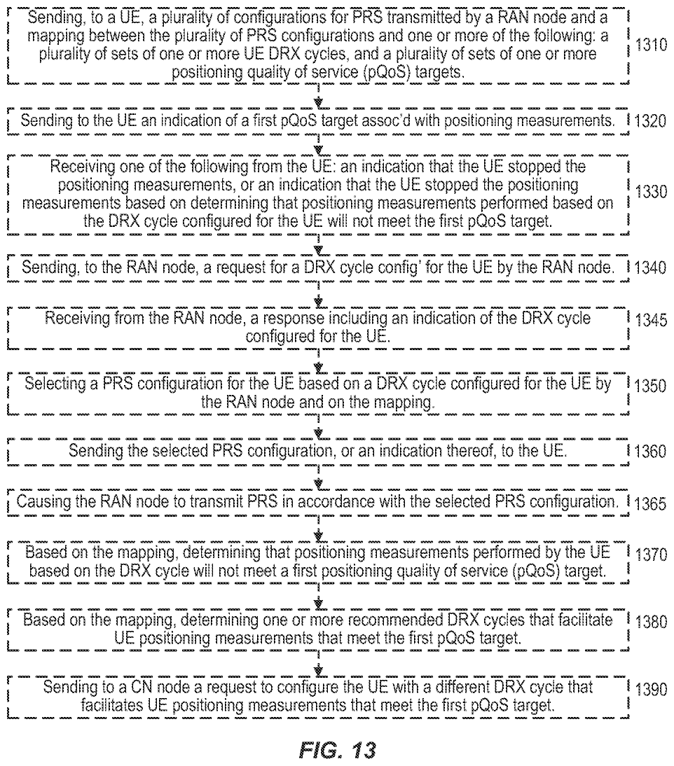

In addition, FIG. 13 shows an exemplary method (e.g., procedure) for a positioning node associated with a radio access network (RAN), according to various embodiments of the present disclosure. The exemplary method can be performed by a positioning node (e.g., LMF, E-SMLC, SUPL, etc.) described elsewhere herein.

In various embodiments, the exemplary method can include the operations of block 1310, 1350, or 1370. In block 1310, the positioning node can send, to a UE, a plurality of configurations for positioning reference signals (PRS) transmitted by a RAN node and a mapping between the plurality of PRS configurations and one or more of the following:
a PRS configuration based on a DRX cycle configured for the UE by the RAN node; or.
a DRX cycle based on the first pQoS target or on a PRS configuration to be used for the positioning measurements.

In block 1350, the positioning node can select a PRS configuration for the UE based on a DRX cycle configured for the UE by the RAN node and on the mapping. FIG. 11 shows an example of these embodiments. In block 1370, the positioning node can, based on the mapping, determine that positioning measurements performed by the UE based on the DRX cycle will not meet a first pQoS target. FIG. 10 shows an example of these embodiments.

) In various embodiments, the plurality of PRS configurations are differentiated from each other based any of the characteristics or parameters discussed above for UE embodiments.

In some embodiments, each pQoS target is associated with one or more of the following: an accuracy criterion, and a latency criterion. In some of these embodiments, the plurality of PRS configurations can include first, second, and third configurations such as discussed above for UE embodiments.

In various embodiments, the mapping can have any of the characteristics or features discussed above for UE embodiments.

In some embodiments, the exemplary method can also include the operations of blocks 1340-1345, where the positioning node can send to the RAN node a request for a DRX cycle configured for the UE by the RAN node and receive from the RAN node a response including an indication of the DRX cycle configured for the UE. In such case, selecting the PRS configuration in block 1350 is based on the mapping and on the DRX cycle indicated by the RAN node. In some of these embodiments, the exemplary method can also include the operations of blocks 1360-1365, where the positioning node can send the selected PRS configuration (or an indication thereof) to the UE and cause the RAN node to transmit PRS in accordance with the selected PRS configuration.

In other embodiments, the exemplary method can also include the operations of block 1390, where the positioning node can, based on determining that positioning measurements performed by the UE based on the DRX cycle will not meet the pQoS target (e.g., in block 1370), send to a CN node a request to configure the UE with a different DRX cycle that facilitates UE positioning measurements that meet the first pQoS target. In some of these embodiments, the exemplary method can also include the operations of block 1380, where the positioning node can, based on the mapping, determine one or more recommended DRX cycles that facilitate UE positioning measurements that meet the first pQoS target. In some variants, the request to the CN node (e.g., in block 1390) includes an indication of the one or more recommended DRX cycles.

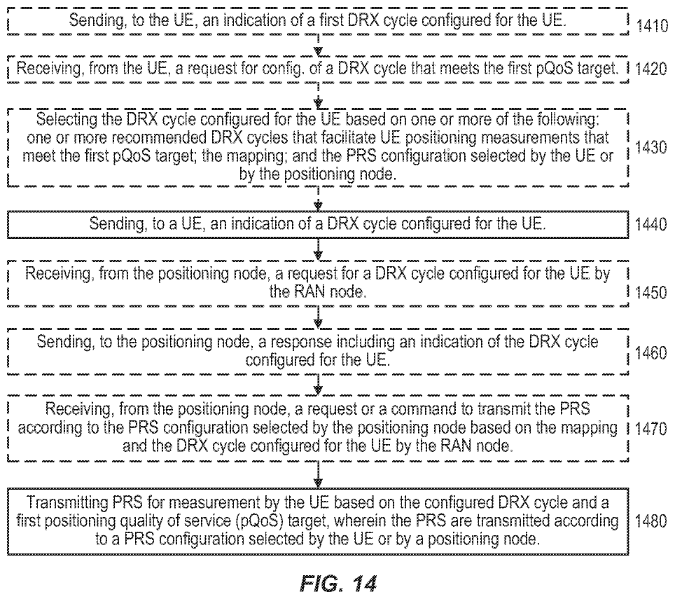

In addition, FIG. 14 shows an exemplary method (e.g., procedure) for a RAN node configured to support positioning of UEs operating in the RAN, according to various embodiments of the present disclosure. The exemplary method can be performed by a RAN node (e.g., base station, eNB, gNB, ng-eNB, TRP, etc.) described elsewhere herein.

The exemplary method can include the operations of block 1440, where the RAN node can send, to a UE, an indication of a DRX cycle configured for the UE. The exemplary method can also include the operations of block 1480, where the RAN node can transmit PRS for measurement by the UE based on the configured DRX cycle and on a first pQOS target. The PRS are transmitted according to a PRS configuration selected by the UE or by a positioning node. The PRS configuration or the DRX cycle is selected based on a mapping between a plurality of PRS configurations and one or more of the following: a plurality of sets of one or more UE DRX cycles, and a plurality of sets of one or more pQoS targets.

In various embodiments, the plurality of PRS configurations are differentiated from each other based any of the characteristics or parameters discussed above for UE embodiments.

In some embodiments, each pQOS target is associated with one or more of the following: an accuracy criterion, and a latency criterion. In some of these embodiments, the plurality of PRS configurations can include first, second, and third configurations such as discussed above for UE embodiments.

In various embodiments, the mapping can have any of the characteristics or features discussed above for UE embodiments.

In some embodiments, the exemplary method can also include the operations of blocks 1410-1420, where the RAN node can send to the UE an indication of a first DRX cycle configured for the UE and receive from the UE a request for configuration of a DRX cycle that meets the first pQoS target. The indication of the DRX cycle configured for the UE is sent (e.g., in block 1440) in response to the request. In some of these embodiments, the exemplary method can also include the operations of block 1430, where the RAN node can select the DRX cycle configured for the UE based on one or more of the following:
one or more recommended DRX cycles that facilitate UE positioning measurements that meet the first pQoS target, indicated in the request;
the mapping; and
the PRS configuration selected by the UE or by the positioning node.

In some of these embodiments, the DRX cycle configured for the UE is less than the first DRX cycle.

In other embodiments, the exemplary method can also include the operations of blocks 1450-1460, where the RAN node can receive from the positioning node a request for a DRX cycle configured for the UE by the RAN node and send to the positioning node a response including an indication of the DRX cycle configured for the UE. In some of these embodiments the exemplary method can also include the operations of block 1470, where the RAN node can receive, from the positioning node, a request or a command to transmit the PRS according to the PRS configuration selected by the positioning node based on the mapping and the DRX cycle configured for the UE by the RAN node. The RAN node can transmit the PRS (e.g., in block 1480) in response to the request or command.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

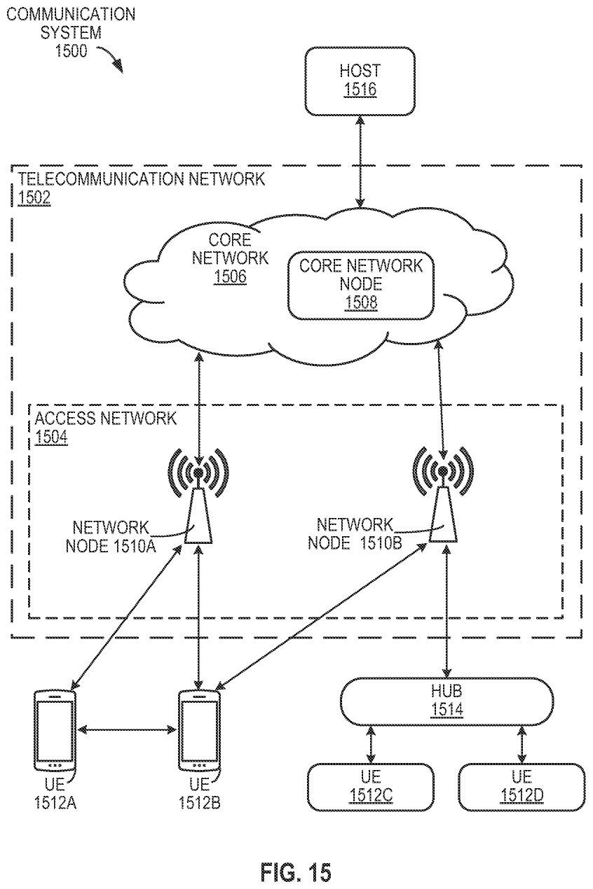

FIG. 15 shows an example of a communication system 1500 in accordance with some embodiments. In this example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3rd Generation Partnership Project (3GPP) access node or non-3GPP access point. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

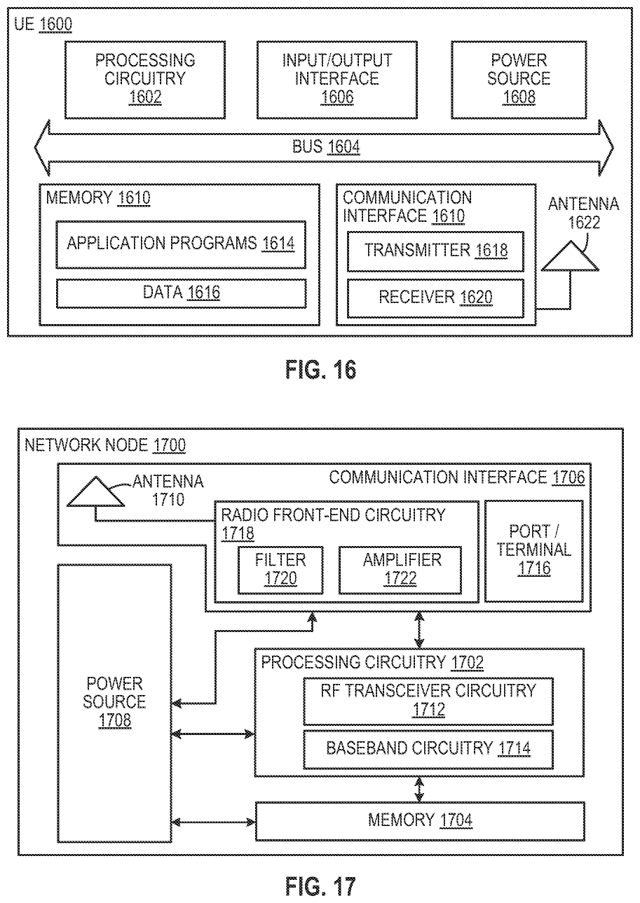

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing 10) circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part 30) of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the techniques and apparatus described herein also include, but are not limited to, the following enumerated examples:

A1. A method for a user equipment (UE) configured for positioning in a radio access network (RAN), the method comprising:
receiving, from a positioning node associated with the RAN, a plurality of configurations for positioning reference signals (PRS) transmitted by a RAN node and a mapping between the plurality of PRS configurations and one or more of the following:
   a plurality of sets of one or more UE discontinuous reception (DRX) cycles, and
   a plurality of sets of one or more positioning quality of service (pQoS) targets;
determining a need to perform positioning measurements associated with a first pQos target;
obtaining one of the following based on the mapping:
   a PRS configuration based on a DRX cycle configured for the UE by the RAN node; or
   a DRX cycle based on the first pQoS target or on a PRS configuration to be used for the positioning measurements; and
performing positioning measurements on PRS transmitted by the RAN node according to the PRS configuration and based on the DRX cycle.

A2. The method of embodiment A1, wherein the plurality of PRS configurations are differentiated from each other based on one or more of the following characteristics or parameters:
PRS transmission periodicity;
PRS transmission bandwidth;
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

A3. The method of any of embodiments A1-A2, wherein each pQoS target is associated with one or more of the following: an accuracy criterion, and a latency criterion.

A4. The method of embodiment A3, wherein the plurality of PRS configurations include:
a first PRS configuration associated with a high accuracy criterion and a low latency criterion;
a second PRS configuration associated with a medium accuracy criterion and a medium latency criterion; and
a third PRS configuration associated with a low accuracy criterion and a high latency criterion.

A5. The method of any of embodiments A1-A4, wherein the mapping includes:
an explicit mapping between the plurality of PRS configurations and the respective plurality of sets of DRX cycles, and
an implicit mapping between the plurality of PRS configurations and a corresponding plurality of pQoS targets, based on the DRX cycles included in the respective sets.

A6. The method of embodiment A5, wherein obtaining based on the mapping comprises:
receiving, from the RAN node, an indication of the DRX cycle configured for the UE; and
selecting the PRS configuration associated with the configured DRX cycle according to the mapping.

A7. The method of embodiment A5, wherein obtaining based on the mapping comprises: receiving, from the RAN node, an indication of a first DRX cycle configured for the UE; receiving, from the positioning node, an indication of the first pQoS target; and based on the mapping, determining whether positioning measurements performed based on the first DRX cycle will meet the first pQoS target.

A8. The method of embodiment A7, wherein obtaining based on the mapping further comprises:
based on determining that positioning measurements performed based on the first DRX cycle will not meet the first pQoS target, sending to the RAN node a request for configuration of a DRX cycle that meets the first pQoS target; and
receiving, from the RAN node in response to the request, an indication of the DRX cycle configured for the UE.

A8a. The method of embodiment A8, wherein the request includes an indication one or more recommended DRX cycles that facilitate UE positioning measurements that meet the first pQos target.

A9. The method of any of embodiments A8-A8a, wherein the DRX cycle configured for the UE is less than the first DRX cycle.

A10. The method of any of embodiments A8-A9, wherein performing the positioning measurements comprises:
initiating the positioning measurements according to the PRS configuration based on the first DRX cycle;
suspending the positioning measurements based on determining that positioning measurements performed based on the first DRX cycle will not meet the first pQOS target; and
resuming the positioning measurements based on the DRX cycle configured for the UE.

A11. The method of embodiment A7, wherein performing the positioning measurements comprises:
initiating the positioning measurements according to the PRS configuration based on the first DRX cycle;
stopping the positioning measurements based on determining that positioning measurements performed based on the first DRX cycle will not meet the first pQoS target; and
sending, to the positioning node, an indication that the UE stopped the positioning measurements and an indication of a cause for the stopping.

A12. The method of embodiment A11, wherein stopping the positioning measurements is further based on determining that the first DRX cycle is one or more of the following: less than a threshold, or a shortest available DRX cycle for the UE's radio resource control (RRC) state with respect to the RAN node.

A13. The method of any of embodiments A1-A4, wherein the mapping includes:
a first mapping between the plurality of PRS configurations and a corresponding plurality of sets of pQoS targets; and
a second mapping of a single set of DRX cycles to all of the PRS configurations and to all of the sets of pQoS targets.

A14. The method of embodiment A13, wherein obtaining based on the mapping comprises:
receiving, from the positioning node, an indication of the first pQoS target; and
selecting the PRS configuration associated with the first QoS target according to the mapping.

B1. A method for a positioning node associated with a radio access network (RAN), the method comprising one of the following:
sending, to the UE, a plurality of configurations for positioning reference signals (PRS) transmitted by a RAN node and a mapping between the plurality of PRS configurations and one or more of the following:
   a plurality of sets of one or more UE discontinuous reception (DRX) cycles, and
   a plurality of sets of one or more positioning quality of service (pQoS) targets;
selecting a PRS configuration for the UE based on a DRX cycle configured for the UE by the RAN node and on the mapping; or
based on the mapping, determining that positioning measurements performed by the UE based on the DRX cycle will not meet a first positioning quality of service (pQoS) target.

B2. The method of embodiment B1-B1a, wherein the plurality of PRS configurations are differentiated from each other based on one or more of the following characteristics or parameters:
PRS transmission periodicity;
PRS transmission bandwidth;
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

B3. The method of any of embodiments B1-B2, wherein each pQoS target is associated with one or more of the following: an accuracy criterion, and a latency criterion.

B4 The method of embodiment B3, wherein the plurality of PRS configurations include: a first PRS configuration associated with a high accuracy criterion and a low latency criterion;
a second PRS configuration associated with a medium accuracy criterion and a medium latency criterion; and
a third PRS configuration associated with a low accuracy criterion and a high latency criterion.

B5. The method of any of embodiments B1-B4, wherein the mapping includes:
an explicit mapping between the plurality of PRS configurations and the respective plurality of sets of DRX cycles, and
an implicit mapping between the plurality of PRS configurations and a corresponding plurality of pQoS targets, based on the DRX cycles included in the respective sets.

B6. The method of any of embodiments B1-B4, wherein the mapping includes:
a first mapping between the plurality of PRS configurations and a corresponding plurality of sets of pQoS targets; and
a second mapping of a single set of DRX cycles to all of the PRS configurations and to all of the sets of pQoS targets.

B7. The method of any of embodiments B1-B6, further comprising after sending the plurality of configurations, sending to the UE an indication of a first pQoS target associated with positioning measurements.

B8. The method of embodiment B7, further comprising receiving one of the following from the UE:
an indication that the UE stopped the positioning measurements, or
an indication that the UE stopped the positioning measurements based on determining that positioning measurements performed based on the DRX cycle configured for the UE will not meet the first pQoS target.

B9. The method of any of embodiments B1-B6, further comprising:
sending, to the RAN node, a request for a DRX cycle configured for the UE by the RAN node; and
receiving from the RAN node, a response including an indication of the DRX cycle configured for the UE,
wherein selecting the PRS configuration is based on the mapping and on the DRX cycle indicated by the RAN node.

B10. The method of embodiment B9, further comprising:
sending the selected PRS configuration, or an indication thereof, to the UE; and
causing the RAN node to transmit PRS in accordance with the selected PRS configuration.

B11. The method of any of embodiments B1-B6, further comprising based on determining that positioning measurements performed by the UE based on the DRX cycle will not meet the pQoS target, sending to a core network (CN) node a request to configure the UE with a different DRX cycle that facilitates UE positioning measurements that meet the first pQoS target.

B12. The method of embodiment B11, further comprising, based on the mapping, determining one or more recommended DRX cycles that facilitate UE positioning measurements that meet the first pQoS target.

B13. The method of embodiment B12, wherein the request to the CN node includes an indication of the one or more recommended DRX cycles.

C1. A method for a radio access network (RAN) node configured to support positioning of user equipment (UEs) operating in the RAN, the method comprising:
sending, to a UE, an indication of a discontinuous reception (DRX) cycle configured for the UE; and
transmitting positioning reference signals (PRS) for measurement by the UE based on the configured DRX cycle and on a first positioning quality of service (pQoS) target, wherein:
   the PRS are transmitted according to a PRS configuration selected by the UE or by a positioning node,
   the PRS configuration or the DRX cycle is selected based on a mapping between
      a plurality of PRS configurations and one or more of the following:
      a plurality of sets of one or more UE DRX cycles, and
      a plurality of sets of one or more pQoS targets.

C2. The method of embodiment C1, wherein the plurality of PRS configurations are differentiated from each other based on one or more of the following characteristics or parameters:
PRS transmission periodicity;
PRS transmission bandwidth;
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area;
positioning spatial dimension;
positioning accuracy quality of service (QOS); and
positioning latency QoS.

C3. The method of any of embodiments C1-C2, wherein each pQoS target is associated with one or more of the following: an accuracy criterion, and a latency criterion.

C4. The method of embodiment C3, wherein the plurality of PRS configurations include:
a first PRS configuration associated with a high accuracy criterion and a low latency criterion;
a second PRS configuration associated with a medium accuracy criterion and a medium latency criterion; and
a third PRS configuration associated with a low accuracy criterion and a high latency criterion.

C5. The method of any of embodiments C₁-C₄, wherein the mapping includes:
an explicit mapping between the plurality of PRS configurations and the respective plurality of sets of DRX cycles, and
an implicit mapping between the plurality of PRS configurations and a corresponding plurality of pQOS targets, based on the DRX cycles included in the respective sets.

C6. The method of embodiment C5, further comprising:
sending, to the UE, an indication of a first DRX cycle configured for the UE; and
receiving, from the UE, a request for configuration of a DRX cycle that meets the first pQOS target,
wherein the indication of the DRX cycle configured for the UE is sent in response to the request.

C7. The method of embodiment C6, further comprising selecting the DRX cycle configured for the UE based on one or more of the following:
one or more recommended DRX cycles that facilitate UE positioning measurements that meet the first pQOS target, indicated in the request;
the mapping, and
the PRS configuration selected by the UE or by the positioning node.

C8. The method of any of embodiments C5-C6, wherein the DRX cycle configured for the UE is less than the first DRX cycle.

C9. The method of any of embodiments C₁-C₄, wherein the mapping includes:
a first mapping between the plurality of PRS configurations and a corresponding plurality of sets of pQoS targets; and
a second mapping of a single set of DRX cycles to all of the PRS configurations and to all of the sets of pQoS targets.

C10. The method of any of embodiments C1-C9, further comprising:
receiving, from the positioning node, a request for a DRX cycle configured for the UE by the RAN node; and
sending, to the positioning node, a response including an indication of the DRX cycle configured for the UE.

C11. The method of embodiment C10, further comprising receiving, from the positioning node, a request or a command to transmit the PRS according to the PRS configuration selected by the positioning node based on the mapping and the DRX cycle configured for the UE by the RAN node.

D1. A user equipment (UE) configured for positioning in a radio access network (RAN), the UE comprising:
communication interface circuitry configured to communicate with RAN nodes and with a positioning node associated with the RAN; and
processing circuitry operatively coupled to the radio transceiver circuitry, whereby the processing circuitry and the radio transceiver circuitry are configured to perform operations corresponding to any of the methods of embodiments A1-A14.

D2. A user equipment (UE) configured for positioning in a radio access network (RAN), the UE being further configured to perform operations corresponding to any of the methods of embodiments A1-A14.

D3. A non-transitory, computer-readable medium storing computer-executable instructions that, when executed by processing circuitry of a user equipment (UE) configured for positioning in a radio access network (RAN), configure the UE to perform operations corresponding to any of the methods of embodiments A1-A14.

D4. A computer program product comprising computer-executable instructions that, when executed by processing circuitry of a user equipment (UE) configured for positioning in a radio access network (RAN), configure the UE to perform operations corresponding to any of the methods of embodiments A1-A14.

E1. A positioning node configured to operate with a radio access network (RAN), the positioning node comprising:
communication interface circuitry configured to communicate with RAN nodes and with user equipment (UE) operating in the RAN; and
processing circuitry operatively coupled to the communication interface circuitry, whereby the processing circuitry and the communication interface circuitry are configured to perform operations corresponding to any of the methods of embodiments B1-B12.

E2. A positioning node configured to operate with a radio access network (RAN), the positioning node being further configured to perform operations corresponding to any of the methods of embodiments B1-B12.

E3. A non-transitory, computer-readable medium storing computer-executable instructions that, when executed by processing circuitry of a positioning node configured to operate with a radio access network (RAN), configure the positioning node to perform operations corresponding to any of the methods of embodiments B1-B12.

E4. A computer program product comprising computer-executable instructions that, when executed by processing circuitry of a positioning node configured to operate with a radio access network (RAN), configure the positioning node to perform operations corresponding to any of the methods of embodiments B1-B12.

F1. A radio access network (RAN) node configured to support positioning of user equipment (UEs) operating in the RAN, the RAN node comprising:
communication interface circuitry configured to communicate with user equipment (UEs) and with a positioning node; and
processing circuitry operatively coupled to the communication interface circuitry, whereby the processing circuitry and the communication interface circuitry are configured to perform operations corresponding to any of the methods of embodiments C1-C11.

F2. A radio access network (RAN) node configured to support positioning of user equipment (UEs) operating in the RAN, the RAN node being further configured to perform operations corresponding to any of the methods of embodiments C1-C11.

F3. A non-transitory, computer-readable medium storing computer-executable instructions that, when executed by processing circuitry of a radio access network (RAN) node configured to support positioning of user equipment (UEs) operating in the RAN, configure the RAN node to perform operations corresponding to any of the methods of embodiments C1-C11.

F4. A computer program product comprising computer-executable instructions that, when executed by processing circuitry of a radio access network (RAN) node configured to support positioning of user equipment (UEs) operating in the RAN, configure the RAN node to perform operations corresponding to any of the methods of embodiments C1-C11.

### FURTHER EXTENSIONS AND VARIATIONS

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

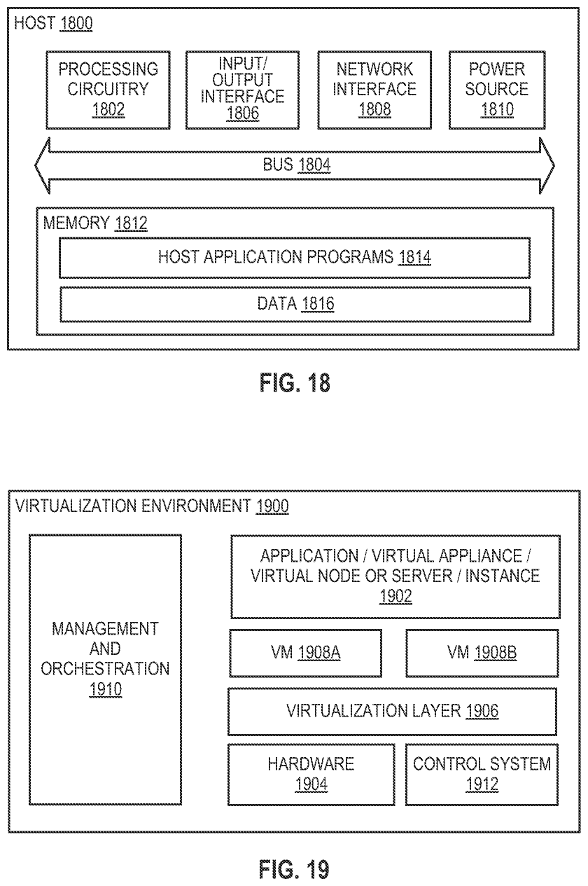

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g., such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

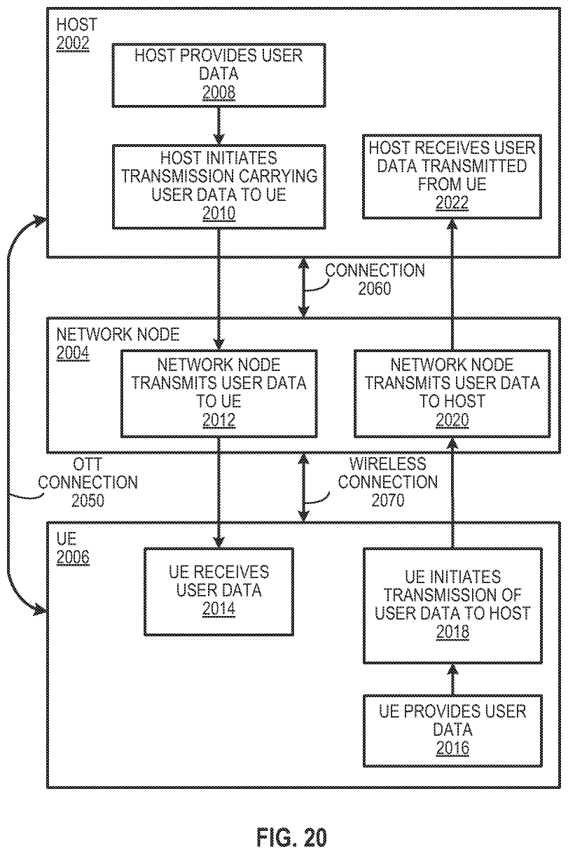

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment. More precisely, embodiments described herein can allow, enable, and/or facilitate a network to provide UE DRX configurations that are specific to and/or compatible with PRS configurations used by the UE, such as a UE-selected one of multiple predefined PRS configurations. In this manner, embodiments provide an improved and/or optimal tradeoff between positioning latency and UE energy consumption. In this manner, embodiments can improve the delivery of positioning-based OTT services by a wireless network, which increases the value of such services to end users and OTT service providers.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-58. (canceled)

59. A method for a user equipment (UE) configured for positioning in a radio access network (RAN), the method comprising:
receiving, from a positioning node, a plurality of configurations for positioning reference signals (PRS) transmitted by a RAN node and a mapping between the plurality of PRS configurations and one or more of the following:
a plurality of sets of one or more UE discontinuous reception (DRX) cycles, and
a plurality of sets of one or more positioning quality of service (pQoS) targets;
obtaining one of the following:
a first PRS configuration, based on the mapping and a first DRX cycle configured for the UE by the RAN node; or
a second DRX cycle, based on the mapping and a first pQoS target; and
performing positioning measurements on PRS transmitted by the RAN node, according to the first PRS configuration and either the first DRX cycle or the second DRX cycle.

60. The method of claim 59, wherein the plurality of PRS configurations are differentiated from each other based on one or more of the following characteristics or parameters:
PRS transmission periodicity;
PRS transmission bandwidth;
PRS resource repetition factor;
PRS symbols in PRS resource;
PRS muting pattern;
PRS subcarrier spacing;
PRS resource set periodicity and slot offset;
PRS resource time gap;
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

61. The method of claim 59, wherein the mapping includes:
an explicit mapping between the plurality of PRS configurations and the respective plurality of sets of DRX cycles, and
an implicit mapping between the plurality of PRS configurations and a corresponding plurality of pQOS targets, based on the DRX cycles included in the respective sets.

62. The method of claim 61, wherein obtaining the first PRS configuration based on the mapping comprises:
receiving, from the RAN node, an indication of the first DRX cycle; and
selecting the first PRS configuration based on the first PRS configuration being associated with the first DRX cycle according to the mapping.

63. The method of claim 61, wherein obtaining the second DRX cycle based on the mapping comprises:
receiving, from the RAN node, an indication of the first DRX cycle;
receiving, from the positioning node, an indication of the first pQoS target; and
based on the mapping, determining whether positioning measurements performed based on the first DRX cycle will meet the first pQoS target.

64. The method of claim 63, wherein obtaining the second DRX cycle based on the mapping further comprises:
based on determining that positioning measurements performed based on the first DRX cycle will not meet the first pQoS target, sending to the RAN node a request for configuration of a DRX cycle that meets the first pQoS target; and
receiving, from the RAN node in response to the request, an indication of the second DRX cycle.

65. The method of claim 64, wherein performing the positioning measurements comprises:
initiating the positioning measurements according to the first PRS configuration based on the first DRX cycle;
suspending the positioning measurements based on determining that positioning measurements performed based on the first DRX cycle will not meet the first pQoS target; and
resuming the positioning measurements based on the second DRX cycle.

66. The method of claim 63, wherein performing the positioning measurements comprises:
initiating the positioning measurements according to the first PRS configuration based on the first DRX cycle;
stopping the positioning measurements based on determining that positioning measurements performed based on the first DRX cycle will not meet the first pQoS target; and
sending, to the positioning node, an indication that the UE stopped the positioning measurements and an indication of a cause for the stopping.

67. A method for a positioning node configured to operate with a radio access network (RAN), the method comprising one of the following:
sending, to a user equipment (UE), a plurality of configurations for positioning reference signals (PRS) transmitted by a RAN node and a mapping between the plurality of PRS configurations and one or more of the following:
a plurality of sets of one or more UE discontinuous reception (DRX) cycles, and a plurality of sets of one or more positioning quality of service (pQoS) targets;
selecting a PRS configuration for the UE based on a DRX cycle configured for the UE by the RAN node and on the mapping; or
based on the mapping, determining that positioning measurements performed by the UE based on the DRX cycle will not meet a first pQoS target.

68. The method of claim 67, wherein the plurality of PRS configurations are sent to the UE, with the plurality of PRS configurations being differentiated from each other based on one or more of the following characteristics or parameters:
PRS transmission periodicity;
PRS transmission bandwidth;
PRS resource repetition factor;
PRS symbols in PRS resource;
PRS muting pattern;
PRS subcarrier spacing;
PRS resource set periodicity and slot offset;
PRS resource time gap;
number of PRS transmission frequency layers used;
particular PRS transmission frequency layers used;
number of nodes that transmit PRS;
particular nodes that transmit PRS;
geographic arrangement of nodes that transmit PRS;
number of PRS resource sets per node;
number of PRS per PRS resource set;
energy consumption and/or signaling overhead associated with transmitting PRS according to the configuration;
relevant geographic area; and
positioning spatial dimension.

69. The method of claim 67, wherein the mapping includes:
an explicit mapping between the plurality of PRS configurations and the respective plurality of sets of DRX cycles, and
an implicit mapping between the plurality of PRS configurations and a corresponding plurality of pQOS targets, based on the DRX cycles included in the respective sets.

70. The method of claim 67, further comprising:
sending, to the RAN node, a request for a DRX cycle configured for the UE by the RAN node; and
receiving from the RAN node, a response including an indication of the DRX cycle configured for the UE,
wherein the PRS configuration is selected for the UE based on the mapping and on the DRX cycle indicated by the RAN node.

71. A method for a radio access network (RAN) node configured to support positioning of user equipment (UEs), the method comprising:
sending, to a UE, an indication of a discontinuous reception (DRX) cycle configured for the UE; and
transmitting positioning reference signals (PRS) for measurement by the UE based on the configured DRX cycle and on a first positioning quality of service (pQoS) target, wherein:
the PRS are transmitted according to a PRS configuration selected by the UE or by a positioning node, and
the PRS configuration or the DRX cycle is selected based on a mapping between
a plurality of PRS configurations and one or more of the following:
a plurality of sets of one or more UE DRX cycles, and
a plurality of sets of one or more pQoS targets.

72. The method of claim 71, wherein the mapping includes:
an explicit mapping between the plurality of PRS configurations and the respective plurality of sets of DRX cycles, and
an implicit mapping between the plurality of PRS configurations and a corresponding plurality of pQoS targets, based on the DRX cycles included in the respective sets.

73. A user equipment (UE) configured for positioning in a radio access network (RAN), the UE comprising:
communication interface circuitry configured to communicate with RAN nodes and with a positioning node; and
processing circuitry operatively coupled to the communication interface circuitry, wherein the processing circuitry and the communication interface circuitry are configured to:
receive, from the positioning node, a plurality of configurations for positioning reference signals (PRS) transmitted by a RAN node and a mapping between the plurality of PRS configurations and one or more of the following:
a plurality of sets of one or more UE discontinuous reception (DRX) cycles, and
a plurality of sets of one or more positioning quality of service (pQoS) targets;
obtain one of the following:
a first PRS configuration, based on the mapping and a first DRX cycle configured for the UE by the RAN node; or
a second DRX cycle, based on the mapping and a first pQoS target; and
perform positioning measurements on PRS transmitted by the RAN node, according to the first PRS configuration and either the first DRX cycle or the second DRX cycle.

74. The UE of claim 73, wherein the mapping includes:
an explicit mapping between the plurality of PRS configurations and the respective plurality of sets of DRX cycles, and
an implicit mapping between the plurality of PRS configurations and a corresponding plurality of pQOS targets, based on the DRX cycles included in the respective sets.

75. The UE of claim 74, wherein the processing circuitry and the communication interface circuitry are configured to obtain the first PRS configuration based on the mapping by the following operations:
receiving, from the RAN node, an indication of the first DRX cycle; and
selecting the first PRS configuration based on the first PRS configuration being associated with the first DRX cycle according to the mapping.

76. The UE of claim 74, wherein the processing circuitry and the communication interface circuitry are configured to obtain the second DRX cycle based on the mapping by the following operations:
receiving, from the RAN node, an indication of the first DRX cycle;
receiving, from the positioning node, an indication of the first pQoS target; and
based on the mapping, determining whether positioning measurements performed based on the first DRX cycle will meet the first pQoS target;
based on determining that positioning measurements performed based on the first DRX cycle will not meet the first pQoS target, sending to the RAN node a request for configuration of a DRX cycle that meets the first pQoS target; and
receiving, from the RAN node in response to the request, an indication of the second DRX cycle.

77. A positioning node configured to operate with a radio access network (RAN), the positioning node comprising:
communication interface circuitry configured to communicate with RAN nodes and with user equipment (UEs) operating in the RAN; and
processing circuitry operatively coupled to the communication interface circuitry, wherein the processing circuitry and the communication interface circuitry are configured to perform the method of claim 67.

78. A radio access network (RAN) node configured to support positioning of user equipment (UEs), the RAN node comprising:
communication interface circuitry configured to communicate with UEs and with a positioning node; and
processing circuitry operatively coupled to the communication interface circuitry, wherein the processing circuitry and the communication interface circuitry are configured to perform the method of claim 71.
